(19) United States
(12) Patent Application Publication
(10) Pub. No.: US 2018/0037680 A1
(43) Pub. Date: Feb. 8, 2018

(54) LAYERED BODY AND OPTICAL FILM OR LIQUID CRYSTAL ALIGNMENT FILM USING SAME

(71) Applicant: DIC Corporation, Tokyo (JP)

(72) Inventors: Yoshitaka Saito, Kita-adachi-gun (JP); Kazuki Obi, Kita-adachi-gun (JP); Hiroyuki Itou, Kita-adachi-gun (JP); Kouji Sato, Kita-adachi-gun (JP); Hiroshi Hasebe, Kita-adachi-gun (JP); Masanao Takashima, Kita-adachi-gun (JP); Fumiaki Kodera, Kita-adachi-gun (JP)

(73) Assignee: DIC Corporation, Tokyo (JP)

(21) Appl. No.: 15/517,871

(22) PCT Filed: Sep. 29, 2015
(86) PCT No.: PCT/JP2015/077475

§ 371 Date: Apr. 7, 2017

(30) Foreign Application Priority Data
Oct. 1, 2014 (JP) 2014-203031

(51) Int. Cl. C08F 20/40; C08J 5/18; G02F 1/1337; B32B 27/30

(52) U.S. Cl. CPC C08F 20/40; B32B 27/308; C08J 5/18; G02F 1/133711; G02F 1/133788; B32B 2457/206; C08J 2333/14

(57) ABSTRACT

The invention provides an acrylic resin-based transparent substrate having an alignment layer spread thereon, wherein the photo-alignment layer and the substrate are kept tightly bonded to each other. The invention also provides a layered body having an acrylic resin-containing transparent substrate and, as formed on one surface of the transparent substrate by spreading and bonding thereto, a photo-alignment layer containing photo-responsive molecules capable of responding to light. According to the invention, there can be provided an acrylic resin-based transparent substrate having on the surface thereof, a photo-alignment layer having excellent adhesion force and containing photo-responsive molecules capable of responding to light.

### TECHNICAL FIELD

The present invention relates to a layered body, especially to a layered body for optical film or a liquid crystal alignment film.

### BACKGROUND ART

Various optical films (polarization film, retardation film, viewing angle improving film, brightness improving film, etc.) are used in flat panel displays (FPDs) such as liquid crystal displays (LCD), plasma displays (PDP), organic EL displays (OLED), etc. Recently, an optical device or an optical film has been developed, in which an alignment film containing an alignment material for controlling the alignment direction of a liquid crystal compound is formed on a plastic substrate, and further a polymerizable liquid crystal material is aligned thereon. In addition, as a method for controlling the alignment direction of a liquid crystal compound, recently, a photo-alignment film has come to attract attention for solving a problem of alignment unevenness by a rubbing alignment film through device microstructure fabrication or for solving a problem of rubbing debris to be formed in rubbing.

For example, PTL 1 discloses an example of an optical film having a substrate of polyethylene terephthalate (PET) and containing a specific polymer as an alignment material. According to PTL 1, it is disclosed that a polarization layer is formed on the alignment film formed on the surface of polyethylene terephthalate.

### CITATION LIST

### Patent literature

PTL 1: JP-A 2013-33248

### SUMMARY OF INVENTION

### Technical Problem

For example, in the case of realizing sufficient characteristics of an optical film provided with a polymerizable liquid crystal material for forming an optically-anisotropic layer for use in a polarization film a retardation film or the like, as in PTL 1, the alignment film to be employed for aligning the polymerizable liquid crystal material must exhibit sufficient alignment performance. For this, the alignment film is required to be formed in an adequate manner on a substrate, for example, the film is required to be formed homogeneously with no unevenness thereon. Specifically, in an optical film having the configuration that uses a polymerizable liquid crystal material as mentioned above, when the alignment film is not formed in an adequate manner, the polymerizable liquid crystal material could not be sufficiently aligned, therefore causing unevenness or haze increase in the optical film, and consequently, the characteristics of the optical film are worsened and, for example, in use thereof for polarization films, the optical anisotropy would be insufficient. In addition, the alignment film for aligning a polymerizable liquid crystal material or a liquid crystal composition is by itself a member to be in direct contact with a substrate, and therefore has a problem in that, when the adhesion between the alignment film and the substrate is not sufficient, the alignment film is no more practicable.

Recently, an acrylic resin as typified by PMMA or the like, which is a material having a higher total light transmittance than polyethylene terephthalate and excellent in bending strength, has come to attract attention as a substrate for use in liquid crystal display devices or optical devices. However, the acrylic resin itself dissolves in many kinds of solvents, and therefore in the case where an alignment layer is formed on an acrylic resin substrate according to a coating method, there occurs a problem in that the acrylic resin would dissolve in the solution of a precursor of the alignment layer. When the acrylic resin in the surface dissolves out, a flat layer (film) would be difficult to form by itself, and in addition, even when an alignment layer is formed on the surface of the acrylic resin, there occurs another problem in that the adhesion thereof is poor and the layer may readily peel off. For example, as shown in PTL 1, when cyclopentanone is used as the solvent for the photo-alignment agent, there has been confirmed a problem that the acrylic resin in the surface of the acrylic resin substrate dissolves out and therefore the alignment layer could not be formed.

Given the situation, the present invention can provide a transparent acrylic resin substrate on which a photo-alignment layer is spread and bonded to maintain a state where the alignment layer and the substrate are kept in tight adhesion to each other.

### Solution to Problem

As a result of assiduous studies, we have found that, in the case where the substrate is an acrylic resin, an alignment film containing an alignment material is formed in an adequate matter and accordingly unevenness or haze in an optical film can be thereby prevented, and have completed the present invention.

### Advantageous Effects of Invention

According to the present invention, there is provided an acrylic resin transparent substrate having, on the surface thereof, a photo-alignment layer that contains photo-responsive molecules capable of responding to light and having excellent adhesion force.

### DESCRIPTION OF EMBODIMENTS

The first aspect of the present invention is a layered body that has a transparent substrate containing an acrylic resin and, as formed on one surface of the transparent substrate through spreading and bonding thereon (or as another expression, through adhesion thereon), a photo-alignment layer containing photo-responsive molecules capable of responding to light.

According to the present invention, there can be provided a layered body that has a photo-alignment layer uniformly adhering to the surface of a transparent substrate that contains an acrylic resin. An acrylic resin itself dissolved in a large number of solvents, and therefore in the case where a photo-alignment layer is formed on an acrylic resin substrate according to a coating method, the acrylic resin dissolves out also in the solution capable of dissolving photo-responsive molecules to constitute the photo-alignment layer. Consequently, it is difficult to form a fiat layer (film) itself on the surface of an acrylic resin, and even in the case where a photo-alignment layer containing photo-responsive molecules is formed on the surface of an acrylic resin, its adhesion is poor and therefore the layer readily peels off, and consequently, a substrate that maintains a state where a photo-alignment layer is spread and bonded to the substrate and the photo-alignment layer and the substrate are kept in tight adhesion to each other can be provided. However, the present invention is a layered body in which a photo-alignment layer is uniformly adhered to the surface of a transparent substrate without peeling.

The resin material to constitute the transparent substrate containing an acrylic resin in the present invention may be a homopolymer of methyl (meth)acrylate, or a copolymer of methyl methacrylate and methyl acrylate, or a copolymer of methyl methacrylate or methyl acrylate and any other polymerizing compound than methyl methacrylate or methyl acrylate, or may also be a mixed material of the above-mentioned homopolymer and any other polymer, or a mixed material of the above-mentioned copolymer and any other polymer. The acrylic resin is preferably a polymethacrylate.

In the case where the acrylic resin in the present invention is poly(methyl methacrylate (PMMA), the advantageous effects of the present invention can be enjoyed more, and in particular, in the case where the alignment material is a photo-alignment material that utilizes the photo-reactivity of the photo-functional group in the structure thereof, the advantageous effects of the present invention can be enjoyed even more, and in the case where the photo-alignment material is a photo-alignment material that has a cinnamic acid structure, the advantageous effects of the present invention can be enjoyed further more.

In the acrylic acid substrate where the acrylic resin is a copolymer containing a methyl (meth)acrylate structural unit, the content of the methyl (meth)acrylate structural unit therein is at least 50% by mass, preferably 65 to 98.5% by mass, more preferably 75 to 99.5% by mass, even more preferably 80 to 100% by mass.

In the acrylic resin substrate where the acrylic resin is a mixed material containing a homopolymer of methyl (meth)acrylate, the content of PMMA (polymethyl methacrylate) is at least 50% by mass, preferably 65 to 100% by mass, more preferably 75 to 99.5% by mass, even more preferably 80 to 98.5% by mass. By using the resin material containing PMMA to fall within the preferred range, chemical erosion by the solvent constituting the polymer solution in this embodiment can be prevented.

The other polymerizing compound than methyl methacrylate in the PMMA substrate includes, for example, methyl acrylate, ethyl acrylate, n-propyl acrylate, n-butyl acrylate, isobutyl acrylate, 2-ethylhexyl acrylate, ethyl methacrylate, n-propyl methacrylate, n-butyl methacrylate, isobutyl methacrylate, 2-ethylhexyl methacrylate, styrene, styrene derivatives, etc.

The other polymer includes, for example, a polyurethane resin, a polyester resin, a silicone resin, a polyolefin resin, a polystyrene resin, an epoxy resin, a vinyl chloride resin, and a copolymer resin of two or more selected from these choices.

The transparent substrate containing an acrylic resin in the present invention may be optionally subjected to surface treatment for further improving the adhesion thereof to alignment film materials. The treatment includes known methods of corona treatment, plasma treatment, ultraviolet (UV) treatment, etc.

Preferably, the photo-alignment layer in the present invention is spread and bonded nearly entirely on one surface of the acrylic resin-containing transparent substrate so that the photo-alignment layer and the acrylic resin-containing transparent substrate could be in tight adhesion to each other.

The layered body of the present invention is excellent in interlayer adhesion between the acrylic resin-containing transparent substrate and the photo-alignment layer. In the present invention, preferably, the adhesion is evaluated in a cross-cut tape test of former JIS-K-5400.

The photo-alignment layer in the present invention contains photo-responsive molecules capable of responding to light and preferably has high adhesion to the acrylic resin-containing transparent substrate. As described below, if is more preferable that the alignment control force of the layer for a polymerizing liquid crystal compound is high.

Preferably, the photo-responsive molecules in the present invention are of a photo-responsive polymer, more preferably an acrylic photo-responsive polymer, and more concretely, it is preferable that the polymer contains a repeating unit represented by the following general formula (1):

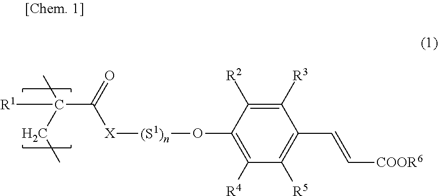

(In the above general formula (1), R¹ represents a hydrogen atom or a methyl group, R², R², R⁴ and R⁵ each independently represent a hydrogen atom, a fluorine atom, an alkyl group having 1 to 6 carbon atoms, or an alkoxy group having 1 to 6 carbon atoms, R⁶ represents a hydrogen atom, or an alkyl group having 1 to 6 carbon atoms which may be substituted with a cyano group or an alkoxy group having 1 to 3 carbon atoms,

X represents —O— or —NH—,

S1 represents —O— or a methylene group which may be substituted with an alkyl group having 1 to 3 carbon atoms and/or a fluorine atom, provided that the oxygen atoms existing in the above general formula (1) are not adjacent to each other, and n represents an integer of 2 to 20.)

In the case where the photo-responsive molecules in the present invention are of an acrylic polymer as shown by the above general formula (1), the material of the transparent substrate on which the alignment layer is formed and the material of the alignment layer are the same in point of the main structure of the two. Consequently, in a coating method of applying a solution that contains acrylic photo-responsive molecules to the acrylic substrate, a solvent that does not dissolve the acrylic resin of the substrate but dissolves the acrylic photo-responsive molecules must be used. When the acrylic substrate dissolves (or is released) out in the coating liquid, the surface of the substrate is corroded and fails in forming an alignment layer thereon. In addition, not only the adhesion between the substrate and the alignment, layer significantly lowers but also the alignment layer would be cloudy therefore providing a problem in that the resultant product could hardly be used as an optical device. However, the problem can be solved by using the general formula (1) of the present invention. In addition, by selecting the solvent to be used in the coating method, a photo-alignment layer can be spread and bonded on the substrate, and there can be provided a substrate in a state where the photo-alignment layer and the substrate are kept in tight adhesion to each other.

In the above general formula (1), R³ is preferably at least one selected from a group consisting of a hydrogen, —CH₂—CH₂—CH, —CH₂—CH₂—O—CH₃, —CH₂—CH₂—O—C₂H₅ and —CH₂—CH₂—O—C₃H₇, and is especially preferably a hydrogen atom. The cinnamic acid structure preferably has a 1-carboxylethen-2-yl group at the terminal.

In the above general formula (1), n is preferably an integer of 2 to 10, more preferably an integer of 3 to 9.

In the above general formula (1), S¹ is preferably methylene. When S¹ is methylene, industrial-scale mass-production of the polymer is easy.

In the above general formula (1), is preferably a methyl group. When R¹ is a methyl group, the polymer having a desired molecular weight is easy to produce, and in addition, as compared with that in the acrylic polymer where R¹ is hydrogen, the double bond part of the cinnamic acid moiety hardly reacts during polymerization reaction.

In the above general formula (1), preferably, R² is a methoxy group and R³, R⁴ and R⁵ are hydrogen atoms. As compared with the compound where R² is a hydrogen atom, the compound where R² is a methoxy group has a superiority difference in point of solubility.

In the above general formula (1), R², R³, R⁴ and R⁵ are preferably hydrogen atoms. The compound where R², R³, R⁴ and R⁵ each is a hydrogen atom is easy to produce in industrial-scale mass-production.

In the above general formula (1), X is preferably —O—.

When X is —O—, the compound is easy to produce in industrial-scale mass-production.

Examples of the alignment material having a specific structure of the compound represented by the general formula (1) as one characteristic feature of the present invention are shown below.

TABLE 1

| Compound No. | R¹ | X | —(S¹)n- | R² | R³ | R⁴ | R⁵ |
|---|---|---|---|---|---|---|---|
| (1-1) | CH₃— | —O— | —(CH₂)₃— | H— | CH₃O— | H— | H— |
| (1-2) | CH₃— | —O— | —(CH₂)₄— | H— | CH₃O— | H— | H— |
| (1-3) | CH₃— | —O— | —(CH₂)₅— | H— | CH₃O— | H— | H— |
| (1-4) | CH₃— | —O— | —(CH₂)₆— | H— | CH₃O— | H— | H— |
| (1-5) | CH₃— | —O— | —(CH₂)₇— | H— | CH₃O— | H— | H— |
| (1-6) | CH₃— | —O— | —(CH₂)₈— | H— | CH₃O— | H— | H— |
| (1-7) | CH₃— | —O— | —(CH₂)₆— | CH₃O— | H— | CH₃O— | H— |
| (1-8) | CH₃— | —O— | —(CH₂)₇— | CH₃O— | H— | CH₃O— | H— |
| (1-9) | CH₃— | —O— | —(CH₂)₈— | CH₃O— | H— | CH₃O— | H— |
| (1-10) | CH₃— | —O— | —(CH₂)₉— | CH₃O— | H— | CH₃O— | H— |
| (1-11) | CH₃— | —O— | —(CH₂)₄— | F— | H— | H— | H— |
| (1-12) | CH₃— | —O— | —(CH₂)₅— | F— | H— | H— | H— |
| (1-13) | CH₃— | —O— | —(CH₂)₆— | F— | H— | H— | H— |
| (1-14) | CH₃— | —O— | —(CH₂)₇— | F— | H— | H— | H— |
| (1-15) | CH₃— | —O— | —(CH₂)₈— | F— | H— | H— | H— |
| (1-16) | CH₃— | —O— | —(CH₂)₉— | F— | H— | H— | H— |
| (1-17) | CH₃— | —O— | —(CH₂)₁₀— | F— | H— | H— | H— |
| (1-18) | CH₃— | —O— | —(CH₂)₂— | H— | F— | H— | H— |
| (1-19) | CH₃— | —NH— | —(CH₂)₃— | H— | F— | H— | H— |
| (1-20) | CH₃— | —O— | —(CH₂)₄— | H— | F— | H— | H— |

TABLE 2

| Compound | | | | | | | |
|---|---|---|---|---|---|---|---|
| No. | R¹ | X | —(S¹)n— | R² | R³ | R⁴ | R⁵ |
| (1-21) | CH₃— | —NH— | —(CH₂)₅— | H— | F— | H— | H— |
| (1-22) | CH₃— | —O— | —(CH₂)₆— | H— | F— | H— | H— |
| (1-23) | CH₃— | —NH— | —(CH₂)₈— | H— | F— | H— | H— |
| (1-24) | CH₃— | —O— | —(CH₂)₄— | F— | F— | H— | H— |
| (1-25) | CH₃— | —NH— | —(CH₂)₆— | F— | F— | H— | H— |
| (1-26) | CH₃— | —O— | —(CH₂)₈— | F— | F— | H— | H— |
| (1-27) | CH₃— | —NH— | —(CH₂)₄— | F— | H— | F— | H— |
| (1-28) | CH₃— | —O— | —(CH₂)₆— | F— | H— | F— | H— |
| (1-29) | CH₃— | —NH— | —(CH₂)₈— | F— | H— | F— | H— |
| (1-30) | CH₃— | —O— | 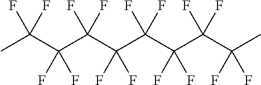 | H— | H— | H— | H— |
| (1-31) | CH₃— | —O— | 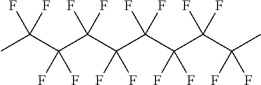 | CH₃O— | H— | H— | H— |
| (1-32) | CH₃— | —O— | 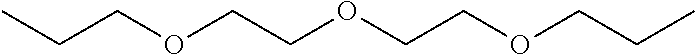 | H— | H— | H— | H— |
| (1-33) | CH₃— | —O— | 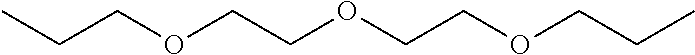 | CH₃O— | H— | H— | H— |
| (1-34) | CH₃— | —O— | 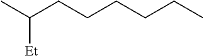 | H— | H— | H— | H— |
| (1-35) | CH₃— | —O— | 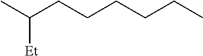 | CH₃O— | H— | H— | H— |
| (1-36) | CH₃— | —O— | 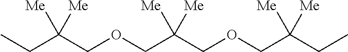 | H— | H— | H— | H— |
| (1-37) | CH₃— | —O— | 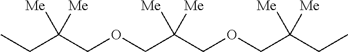 | CH₃O— | H— | H— | H— |
| (1-38) | H— | —O— | —(CH₂)₃— | H— | CH₃O— | H— | H— |
| (1-39) | H— | —O— | —(CH₂)₄— | H— | CH₃O— | H— | H— |
| (1-40) | H— | —O— | —(CH₂)₅— | H— | CH₃O— | H— | H— |

TABLE 3

| Compound No. | R¹ | X | —(S¹)n- | R² | R³ | R⁴ | R⁵ |
|---|---|---|---|---|---|---|---|
| (1-41) | H— | —O— | —(CH₂)₆— | H— | CH₃O— | H— | H— |
| (1-42) | H— | —O— | —(CH₂)₇— | H— | CH₃O— | H— | H— |
| (1-43) | H— | —O— | —(CH₂)₈— | H— | CH₃O— | H— | H— |
| (1-44) | H— | —O— | —(CH₂)₆— | CH₃O— | H— | CH₃O— | H— |
| (1-45) | H— | —O— | —(CH₂)₇— | CH₃O— | H— | CH₃O— | H— |
| (1-46) | H— | —O— | —(CH₂)₈— | CH₃O— | H— | CH₃O— | H— |
| (1-47) | H— | —O— | —(CH₂)₉— | CH₃O— | H— | CH₃O— | H— |
| (1-48) | H— | —O— | —(CH₂)₄— | F— | H— | H— | H— |
| (1-49) | H— | —O— | —(CH₂)₅— | F— | H— | H— | H— |
| (1-50) | H— | —O— | —(CH₂)₆— | F— | H— | H— | H— |
| (1-51) | H— | —O— | —(CH₂)₇— | F— | H— | H— | H— |
| (1-52) | H— | —O— | —(CH₂)₈— | F— | H— | H— | H— |
| (1-53) | H— | —O— | —(CH₂)₉— | F— | H— | H— | H— |
| (1-54) | H— | —O— | —(CH₂)₁₀— | F— | H— | H— | H— |
| (1-55) | H— | —O— | —(CH₂)₂— | H— | F— | H— | H— |
| (1-56) | H— | —NH— | —(CH₂)₃— | H— | F— | H— | H— |
| (1-57) | H— | —O— | —(CH₂)₄— | H— | F— | H— | H— |
| (1-58) | H— | —NH— | —(CH₂)₅— | H— | F— | H— | H— |
| (1-59) | H— | —O— | —(CH₂)₆— | H— | F— | H— | H— |
| (1-60) | H— | —NH— | —(CH₂)₈— | H— | F— | H— | H— |
| (1-61) | H— | —O— | —(CH₂)₄— | F— | F— | H— | H— |
| (1-62) | H— | —NH— | —(CH₂)₆— | F— | F— | H— | H— |
| (1-63) | H— | —O— | —(CH₂)₈— | F— | F— | H— | H— |
| (1-64) | H— | —NH— | —(CH₂)₄— | F— | H— | F— | H— |
| (1-65) | H— | —O— | —(CH₂)₆— | F— | H — | F— | H— |

TABLE 4

| Compound | | | | | | | |
|---|---|---|---|---|---|---|---|
| No. | R¹ | X | —(S¹)n— | R² | R³ | R⁴ | R⁵ |
| (1-66) | H— | —NH— | —(CH₂)₈— | F— | H— | F— | H— |
| (1-67) | H— | —O— | 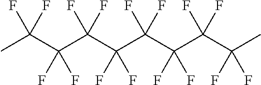 | H— | H— | H— | H— |
| (1-68) | H— | —O— | 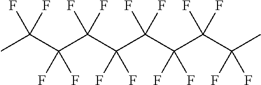 | CH₃O— | H— | H— | H— |
| (1-69) | H— | —O— | 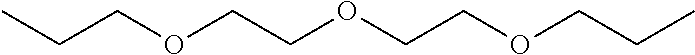 | H— | H— | H— | H— |
| (1-70) | H— | —O— | 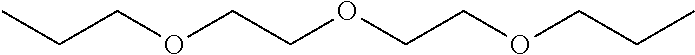 | CH₃O— | H— | H— | H— |
| (1-71) | H— | —O— | 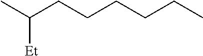 | H— | H— | H— | H— |
| (1-72) | H— | —O— | 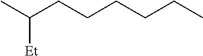 | CH₃O— | H— | H— | H— |
| (1-73) | H— | —O— | 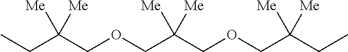 | H— | H— | H— | H— |
| (1-74) | H— | —O— | 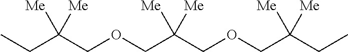 | CH₃O— | H— | H— | H— |

As the photo-responsive molecules represented by the above general formula (1) in the present invention, a polymer represented by the following general formula (2) is more preferred,

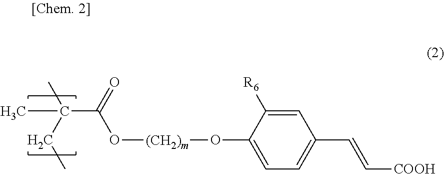

In the above general formula (2), R⁶ represents a hydrogen atom or a methoxy group, and in represents an integer of 2 to 20.

In the above general formula (2), m is preferably an integer of 2 to 10.

Preferred embodiments of the above general formula (2) are as follows:

TABLE 5

| Compound | | |
|---|---|---|
| No. | m | R⁶ |
| (2-1) | 8 | CH₃O— |
| (2-2) | 6 | CH₃O— |
| (2-3) | 2 | CH₃O— |
| (2-4) | 3 | CH₃O— |
| (2-5) | 4 | CH₃O— |
| (2-6) | 5 | CH₃O— |
| (2-7) | 6 | CH₃O— |
| (2-8) | 7 | CH₃O— |
| (2-9) | 9 | CH₃O— |
| (2-10) | 10 | CH₃O— |
| (2-11) | 8 | H— |
| (2-12) | 6 | H— |
| (2-13) | 2 | H— |
| (2-14) | 3 | H— |
| (2-15) | 4 | H— |
| (2-16) | 5 | H— |
| (2-17) | 6 | H— |
| (2-18) | 7 | H— |
| (2-19) | 9 | H— |
| (2-20) | 10 | H— |

Preferred polymers containing the repeating unit represented by the general formula (1) in the present invention are preferably polymers containing a structural unit represented by the following formula (2-1) or formula (2-2):

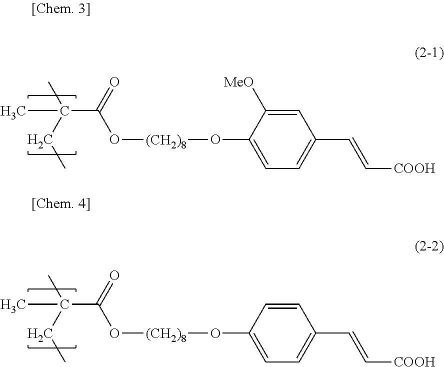

The weight-average molecular weight of the polymer containing the repeating unit represented by the general formula (1) in the present invention is not specifically limited so far as the polymer can enjoy the advantageous effects of the present invention, but from the viewpoint of the balance between the solubility in use as a coating material and the alignment performance, the weight-average molecular weight is preferably within a range of 2,000 to 500,000, more preferably within a range of 5,000 to 300,000, even more preferably within a range of 10,000 to 200,000, and most preferably within a range of 10,000 to 100,000. Molecular weight measurement for the polymer in the present invention can be attained in various measurement methods such as a static light scattering method, GPC, TOFMASS, etc., and in the present invention, the molecular weight is calculated through GPC.

The second aspect of the present invention is an optical film provided with a layered body that has a transparent substrate containing an acrylic resin and, as formed on one surface of the transparent substrate through adhesion to the transparent substrate, a photo-alignment layer containing photo-responsive molecules capable of responding to light, wherein an optically-anisotropic layer having optical anisotropy is formed to be in contact with the surface of the photo-alignment layer formed in the layered body.

Preferably, the optically-anisotropic layer in the present invention contains a polymerizable liquid crystal material. Preferably, the optically-anisotropic layer in the present invention is formed through polymerization of a composition that contains a polymerizable liquid crystal material.

The polymerizing liquid crystal composition to be used in producing an optically-anisotropic body in the present invention is a liquid crystal composition containing a polymerizing liquid crystal and exhibiting liquid crystallinity by itself or in the form of a composition with any other liquid crystal compound. For example, there are mentioned rod-like polymerizing liquid crystal compounds having a rigid moiety called a mesogen where a plurality of structures such as a 1,4-phenylene group, a 1,4-cyclohexylene group and the like connected to each other, and a polymerizing functional group such as a (meth)acryloyloxy group, a vinyloxy group or an epoxy group, as described in Handbook of Liquid Crystals (edited by D. Demus, J. W. Goodby, G. W. Gray, H. W. Spiess, V. Vill, published by Wiley-VCH, 1988), Quarterly Journal Chemical Review, No. 22, Chemistry of Liquid Crystal (edited by The Chemical Society of Japan, 1994), or JP-A 7-294735, JP-A 8-3111, JP-A 8-29618, JP-A 11-80090, JP-A 11-148079, JP-A 2000-178233, JP-A 2002-308831, JP-A 2002-145830; rod-like polymerizing liquid-crystal compounds having a maleimide group as described in JP-A 2004-2373, JP-A 2004-99446; rod-like polymerizing liquid-crystal compounds having an allyl ether group as described in JP-A 2004-149522; and discotic polymerizing compounds as described in, for example, Handbook of Liquid Crystals (edited by D. Demus, J. W. Goodby, G. W. Gray, H. W. Spiess, V. Vill, published by Wiley-VCH, 1988), Quarterly Journal Chemical Review, No. 22, Chemistry of Liquid Crystal (edited by The Chemical Society of Japan, 1994) or JP-A 07-146409. Above all, polymerizing group-having rod-like liquid crystal compounds are preferred since the compounds including those whose liquid crystal temperature range covers low temperatures at around room temperature are easy to produce.

In the case where the polymerizable liquid crystal material to be contained in the polymerizing liquid crystal composition in the present invention contains one or more types of polymerizing liquid crystal compounds and a polymerization initiator and optionally further contains a surfactant and any other additives to form a cholesteric liquid crystal, it is desirable that the material further contains a chiral compound.

The optically-anisotropic layer (for example, retardation layer) in the liquid crystal display device of the present invention uses an optically-anisotropic body obtained through polymerization of a polymerizing liquid crystal composition that contains a liquid crystal compound having 2 or more polymerizing functional groups in an amount of 25% by weight or more.

Specifically, the liquid crystal compound having 2 or more polymerizing functional groups is preferably a compound represented by the following general formula (1):

[Chem. 5]

P¹—(Sp¹)ₘ₁-MG-R¹ (1)

In the formula, P¹ represents a polymerizing functional group, Sp¹ represents an alkylene group having 0 to 18 carbon atoms (the alkylene group may be substituted with one or more of a halogen atom, a CN group, or an alkyl group having 1 to 8 carbon atoms and having a polymerizing functional group, and one CH₂ group or 2 or more CH₂ groups not adjacent to each other existing in this group may be each independently replaced with, in the form where oxygen atoms do not directly bond to each other, —O—, —S—, —NH—, —N(CH₃)—, —CO—, —COO—, —OCO—, —OCOO—, —SCO—, —COS— or —C≡C—), m1 represents 0 or 1, MG represents a mesogen group or a mesogenic supporting group, R¹ represents a hydrogen atom, a halogen atom, a cyano group or an alkyl group having 1 to 18 carbon atoms, and the alkyl group may be substituted with one or more of a halogen atom or CN, and one CH₂ group or 2 or more CH₂ groups not adjacent to each other existing in this group may be each independently replaced with, in the form where oxygen atoms do not directly bond to each other, —O—, —S—, —NH—, —N(CH₃)—, —CO—, —COO—, —OCO—, —OCOO—, —SCO—, —COS— or —C≡C—, or R¹ represents structure represented by a general formula (1-a):

[Chem. 6]

-(Sp^{1a})ₘₐ-P^{1a} (1-a)

(In the formula, P^{1a} represents a polymerizing functional group, Sp^{1a} has the same meaning as that of Sp¹, and ma represents 0 or 1)); the mesogen group or the mesogenic supporting group represented by MG is represented by a general formula (1-b):

[Chem, 7]

—Z0-(A1-Z1)ₙ-(A2-Z2)ₗ-(A3-Z3)ₖ-A4-Z4-A5-Z5- (1-b)

(In the formula, A1, A2, A3, A3, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalane-2,6-diyl group, a pyridine-2,5-diyl group, a pyrimidine-2,5-diyl group, a pyrazine-2,5-diyl group, a thiophene-2,5-diyl group a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group;

the group may have one or more substituents of F, Cl, CF₃, OCF₃, a CN group, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, and an alkenoyloxy group, or one or more substituents represented by a general formula (1-c):

[Chem. 8]

Aₙ₁Sp^{1c}_{mc}P^{c} (1-c)

(In the formula, P^{c} represents a polymerizing functional group, A represents —O—, —COO—, —OCO—, —OCH₂—, —CH₂O—, —CH₂CH₂OCO—, —COOCH₂CH₂—, —OCOCH₂CH₂—, or a single bond, Sp^{1c} has the same meaning as that of Sp¹, n1 represents 0 or 1, and mc represents 0 or 1);

Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond;

n, l and k each independently represent 0 or 1, and 0≦n+l+k≦3). The formula has two or more polymerizing functional groups.

Preferably, P¹, P^{1a} and P^{c} each are a substituent selected from polymerizing groups represented by the following formulae (P-1) to (P-20):

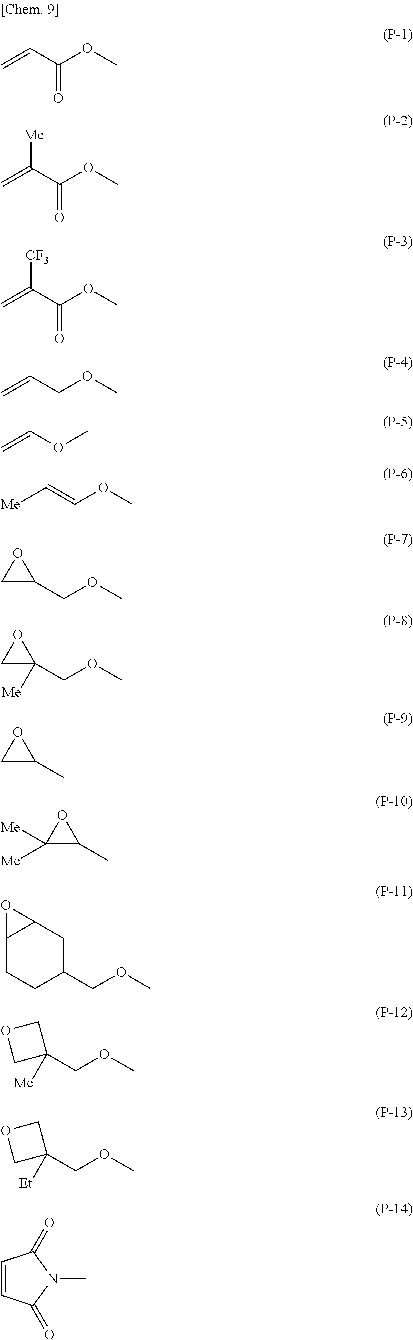

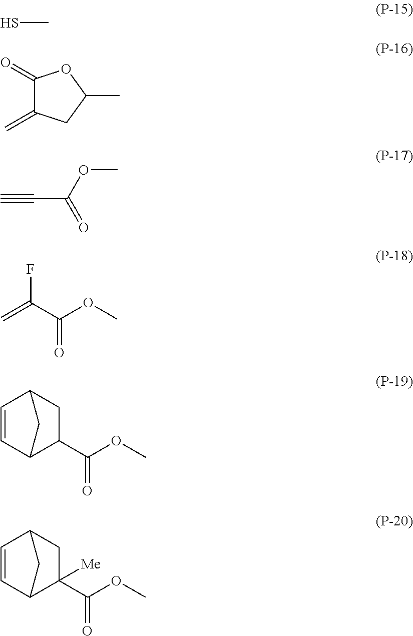

Among these polymerizing functional groups, the formulae (P-1), (P-2), (P-7), (P-12), and (P-13) are preferred from the viewpoint of enhancing polymerization performance and storage stability, and the formulae (P-1), (P-7), and (P-12) are more preferred.

One alone or two or more kinds of liquid crystal compounds having two or more polymerizing functional groups can be used, and using 1 to 6 kinds of the compounds is preferred, and using 2 to 5 kinds of the compounds is more preferred.

The content of the liquid crystal compound having 2 or more polymerizing functional groups is preferably 25 to 100% by mass of the polymerizing liquid crystal composition, more preferably 30 to 100% by mass, even more preferably 35 to 100% by mass.

As the liquid crystal compound having 2 or more polymerizing functional groups, compounds having two polymerizing functional groups are preferred, and compounds represented by the following general formula (2) are preferred.

[Chem. 10]

P^{2a}-(Sp^{2a})ₘ₂-Z0-(A1-Z1)ₙ-(A2-Z2)ₗ-(A3-Z3)ₖ-A4-Z4-A5-Z5-(Sp^{2b})ₙ₂-P^{2b} (2)

In the formula, A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalane-2,6-diyl group, a pyridine-2,5-diyl group, a pyrimidine-2,5-diyl group, a pyrazine-2,5-diyl group, a thiophene-2,5-diyl group a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]bensoselenopheno[3,2-b]selenophene-2,7-diyl group, or a fluorene-2,7-diyl group;

the group may have one or more substituents of F, Cl, CF₃, OCF₃, a CN group, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, and an alkenoyloxy group. Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond;

n, l and k each independently represent 0 or 1, and 0≦n+l+k≦3.

P^{1a} and P^{2b} each represent a polymerizing functional group, Sp^{2a} and Sp^{2b} each independently represent an alkylene group having 0 to 18 carbon atoms (the alkylene group may be substituted with one or more of a halogen atom or CN, and one CH₂ group or 2 or more CH₂ groups not adjacent to each other existing in this group may be each independently replaced with, in the form where oxygen atoms do not directly bond to each other, —O—, —S—, —NH—, —N(CH₃)—, —CO—, —COO—, —OCO—, —OCOO—, —SCO—, —COS— or —C≡C—), m2 and n2 each independently represent 0 or 1.

n, l and k each independently represent 0 or 1, and 0≦n+l+k≦3.

Preferably, P^{2a} and P^{2b} each represent a substituent selected from polymerizing groups represented by the following formulae (P-1) to (P-20):

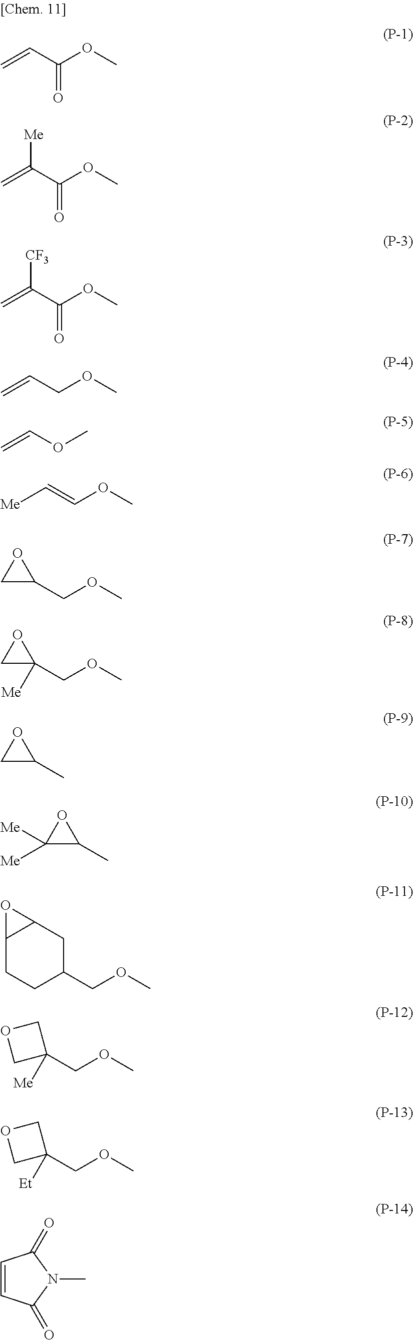

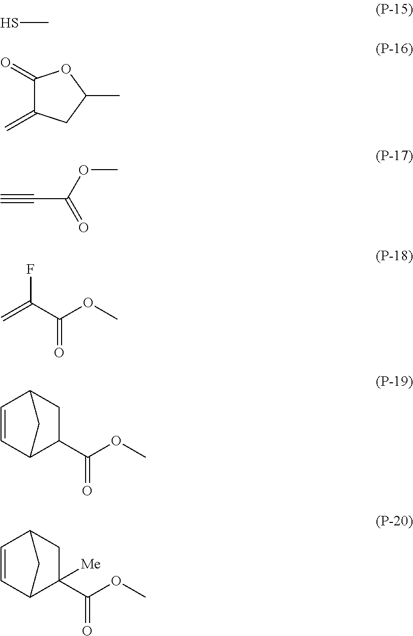

Among these polymerizing functional groups, the formulae (P-1), (P-2), (P-7), (P-12), and (P-13) are preferred from the viewpoint of enhancing polymerization performance and storage stability, and the formulae (P-1), (P-7), and (P-12) are more preferred.

Examples of the general formula (2) include, though not limited thereto, the general formulae (2-1) to (2-4):

[Chem. 12]

P^{2a}-(Sp^{2a})ₘ₂-Z0-A4-Z4-A5-Z5-(Sp^{2b})ₙ₂-P^{2b} (2-1)

P^{2a}-(Sp^{2a})ₘ₂-Z0-A3-Z3-A4-Z4-A5-Z5-(Sp^{2b})ₙ₂-P^{2b} (2-2)

P^{2a}-(Sp^{2a})ₘ₂-Z0-A2-Z2-A3-Z3-A4-Z4-A5-Z5-(Sp^{2b})ₙ₂-P^{2b} (2-3)

P^{2a}-(Sp^{2a})ₘ₂-Z0-A1-Z1-A2-Z2-A3-Z3-A4-Z4-A5-Z5-(Sp^{2b})ₙ₂-P^{2b} (2-4)

In the formulae, P^{2a}, P^{2b}, Sp^{2a}, Sp^{2b}, A1, A2, A3, A4, A5, Z0, Z1, Z2, Z3, Z4, Z5, m2 and n2 are the same as those defined in the general formula (2).

Specific examples of the polymerizing liquid crystal compound having two polymerizing functional groups include compounds of formulae (2-5) to (2-25), but are not limited to the following compounds.

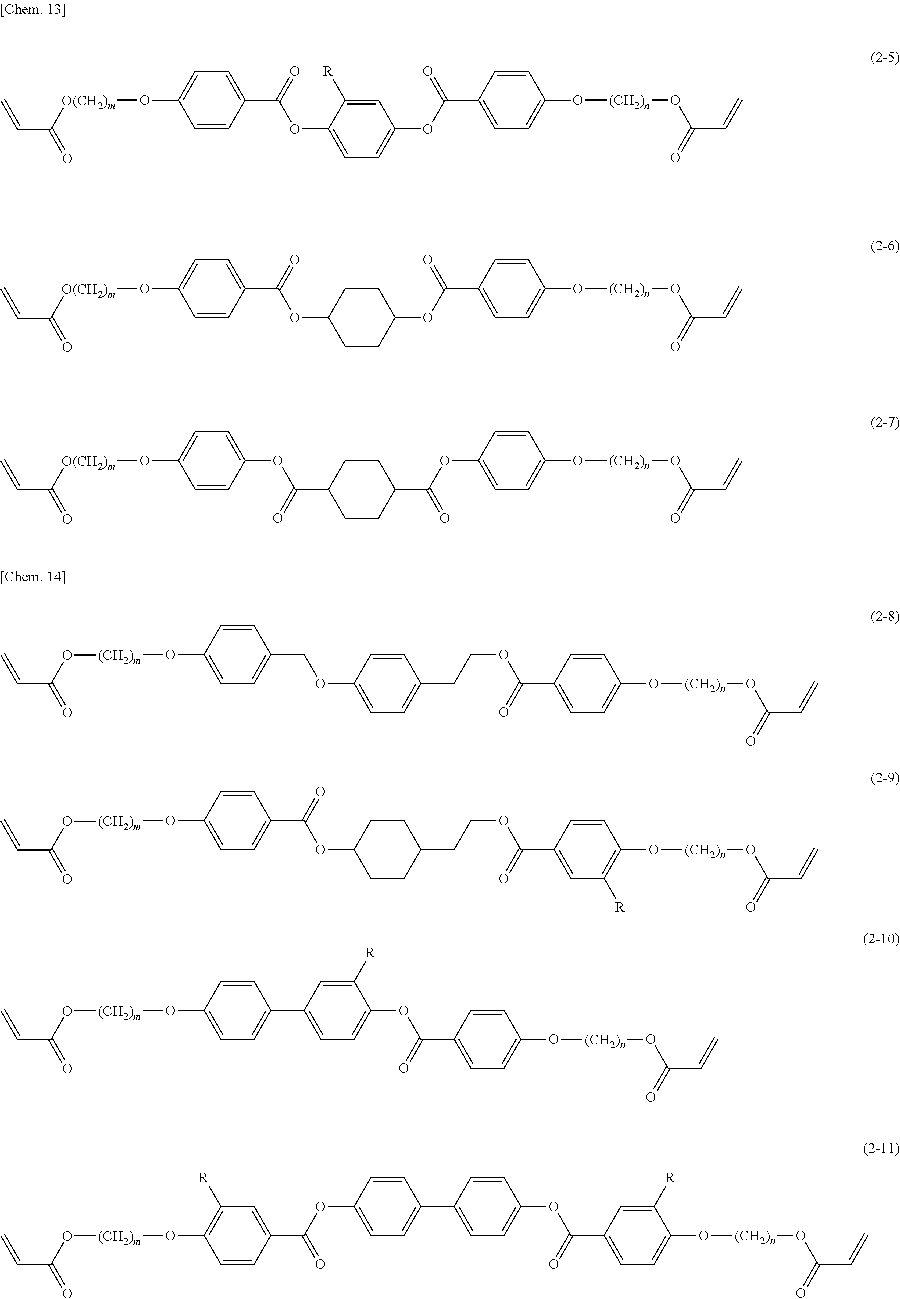

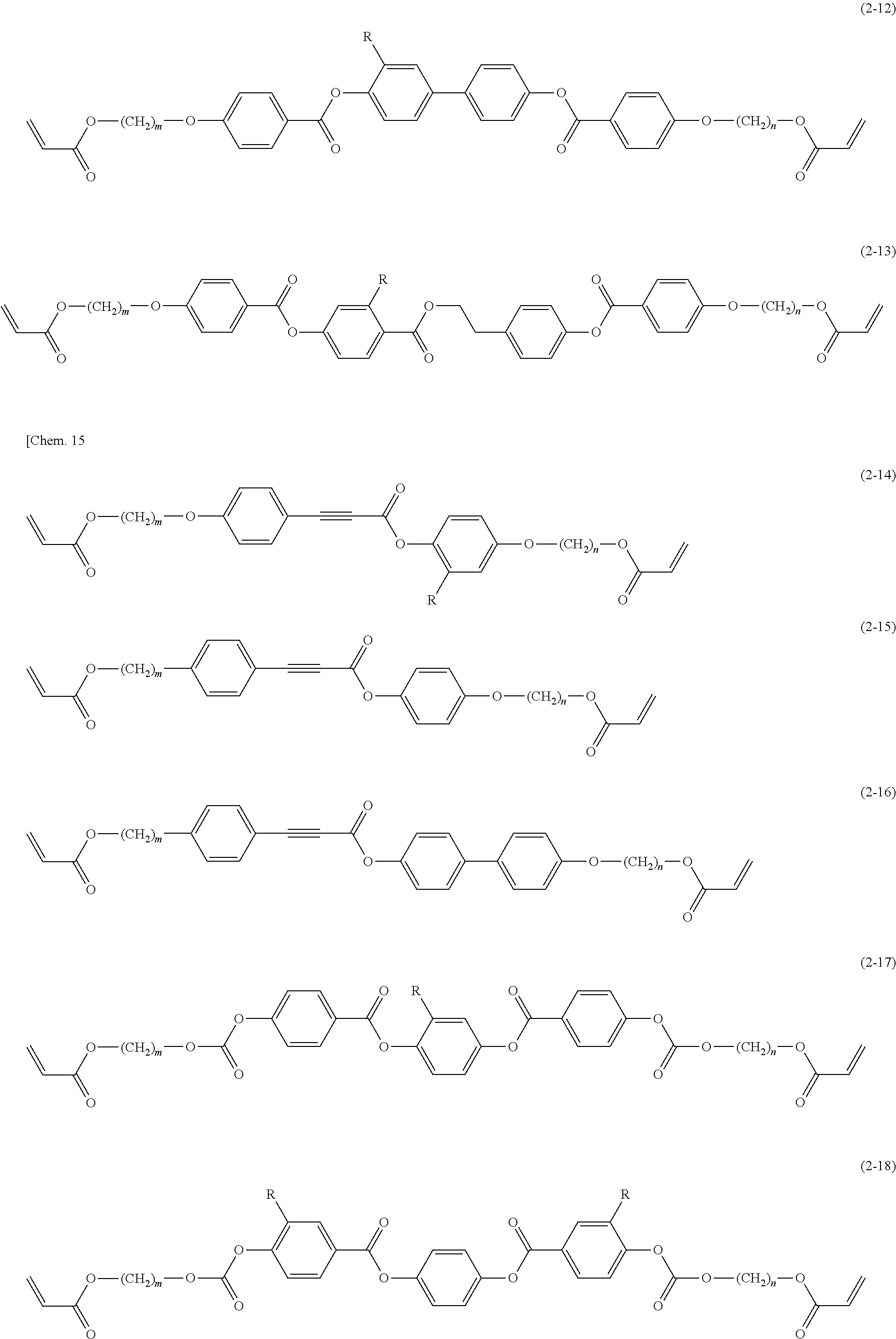

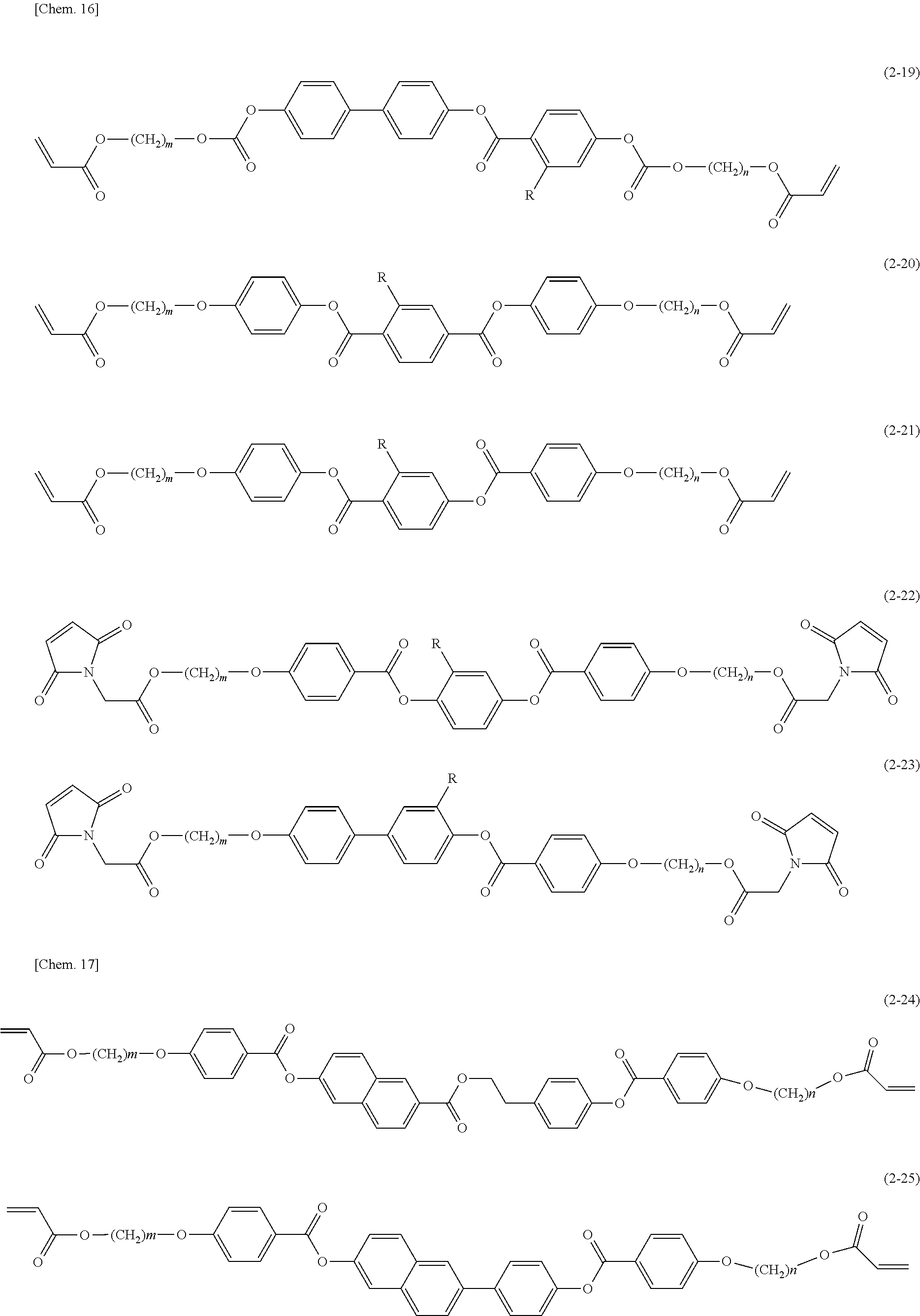

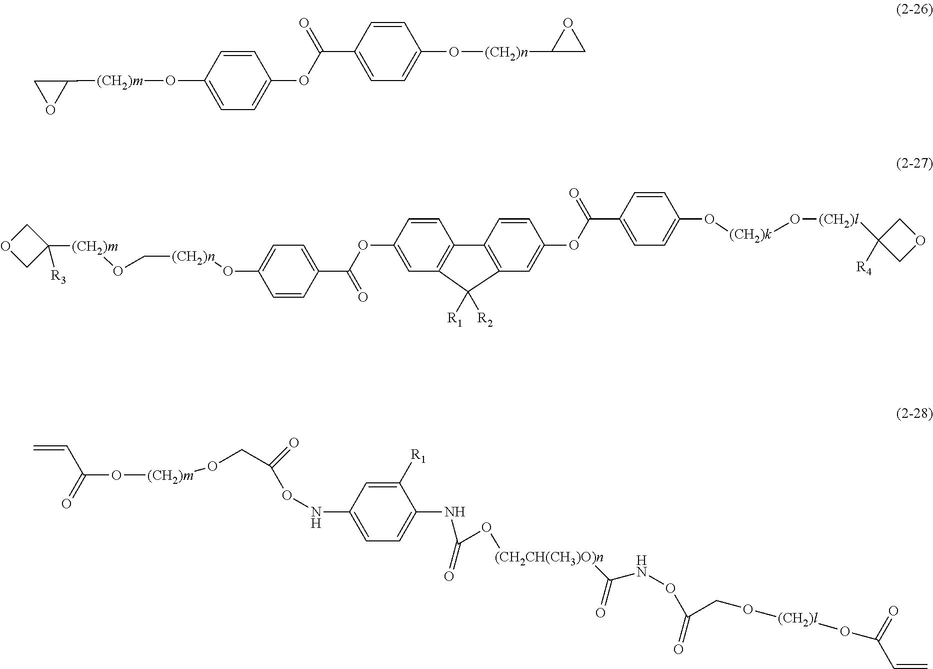

In the formulae (2-5) to (2-28), m, n and l each independently represent an integer of 1 to 18, R, R¹, R², R³, and R⁴ each independently represent a hydrogen atom, a halogen atom, an alkyl group having 1 to 6 carbon atoms, an alkoxy group having 1 to 6 carbon atoms, or a cyano group, and in the case where these groups are an alkyl group having 1 to 6 carbon atoms or an alkoxy group having 1 to 6 carbon atoms, they all are unsubstituted or any of them may be substituted with one or more halogen atoms.

One or more types of liquid crystal compounds having 2 polymerizing functional groups may be used, but 1 to 5 types thereof are preferably used, and 2 to 5 types thereof are more preferably used. The content of the liquid crystal compound having 2 polymerizing functional groups is preferably 25 to 100% by mass of the polymerizing composition, more preferably 30 to 100% by mass, even more preferably 35 to 100% by mass.

The liquid crystal compound having 2 or more polymerizing functional groups is also preferably a compound having 3 polymerizing functional groups. The compound of the type includes those of general formulae (3-1) to (3-18), but is not limited to the following general formulae.

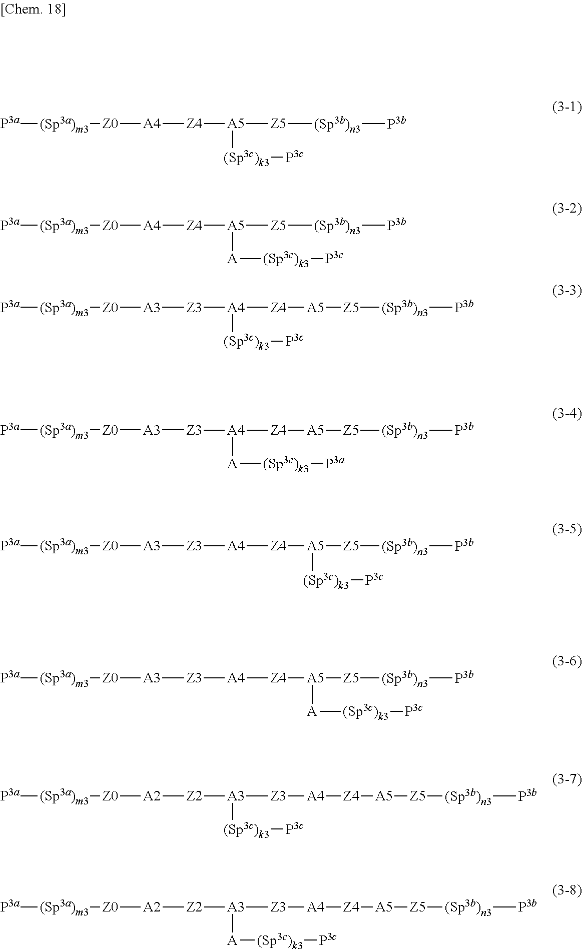

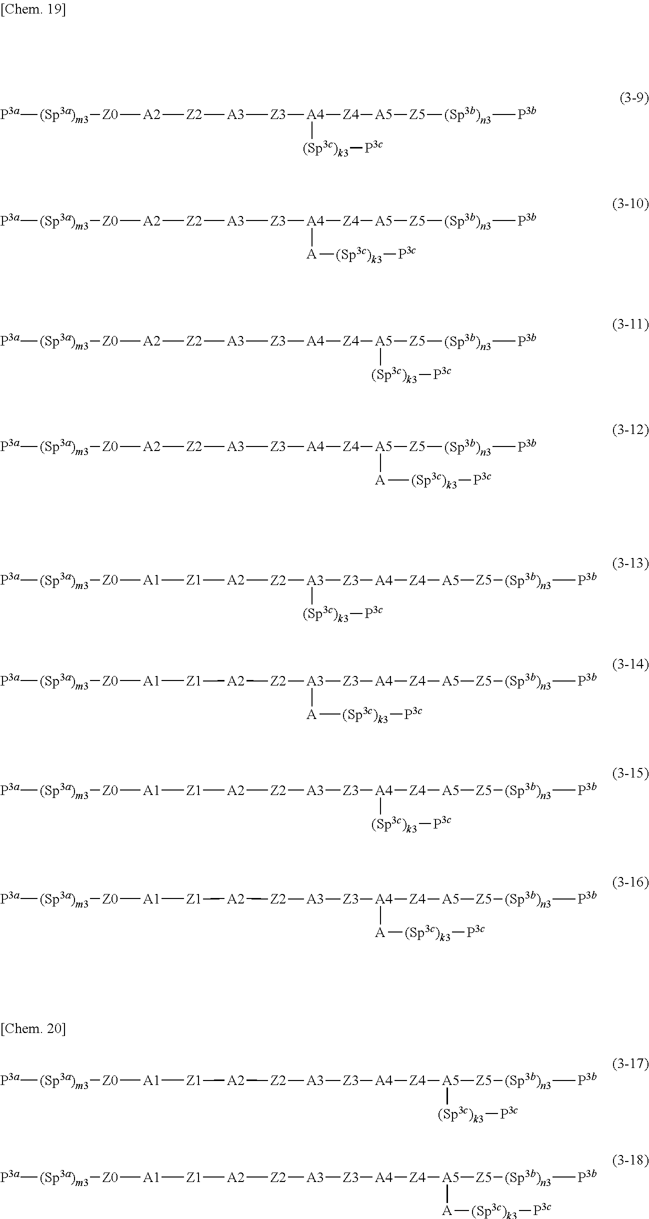

In the formulae, A1, A2, A3, A4, and A5 are the same as those defined in the general formula (2). Also, Z0, Z1, Z2, Z3, Z4, and Z5 are the same as those defined in the general formula (2).

P^{3a}, P^{3b}, and P^{3b} each independently represent a polymerizing functional group, Sp^{3a}, Sp^{3b}, and Sp^{3c} each independently represent an alkylene group having 0 to 18 carbon atoms (the alkylene group may be substituted with one or more of a halogen atom or CN, and one CH₂ group or 2 or more CH₂ groups not adjacent to each other existing in this group may be each independently replaced with, in the form where oxygen atoms do not directly bond to each other, —O—, —S—, —NH—, —N(CH₃)—, —CO—, —COO—, —OCO—, —OCOO—, —SCO—, —COS— or —C≡C—.) m3, n3, and k3 each independently represent 0 or 1.

Specific examples of the polymerizing liquid crystal compound having 2 polymerizing functional groups include, though not limited thereto, compounds of formulae (3-19) to (3-26):

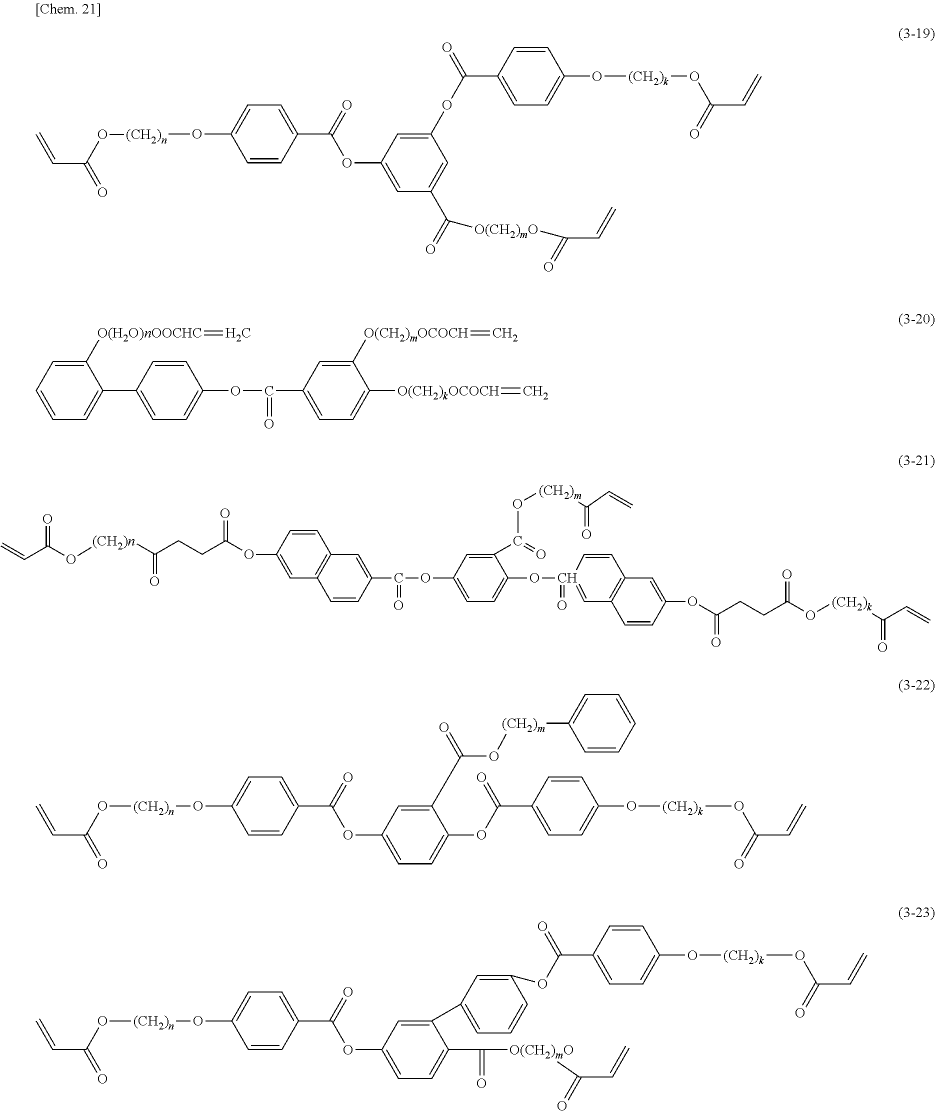

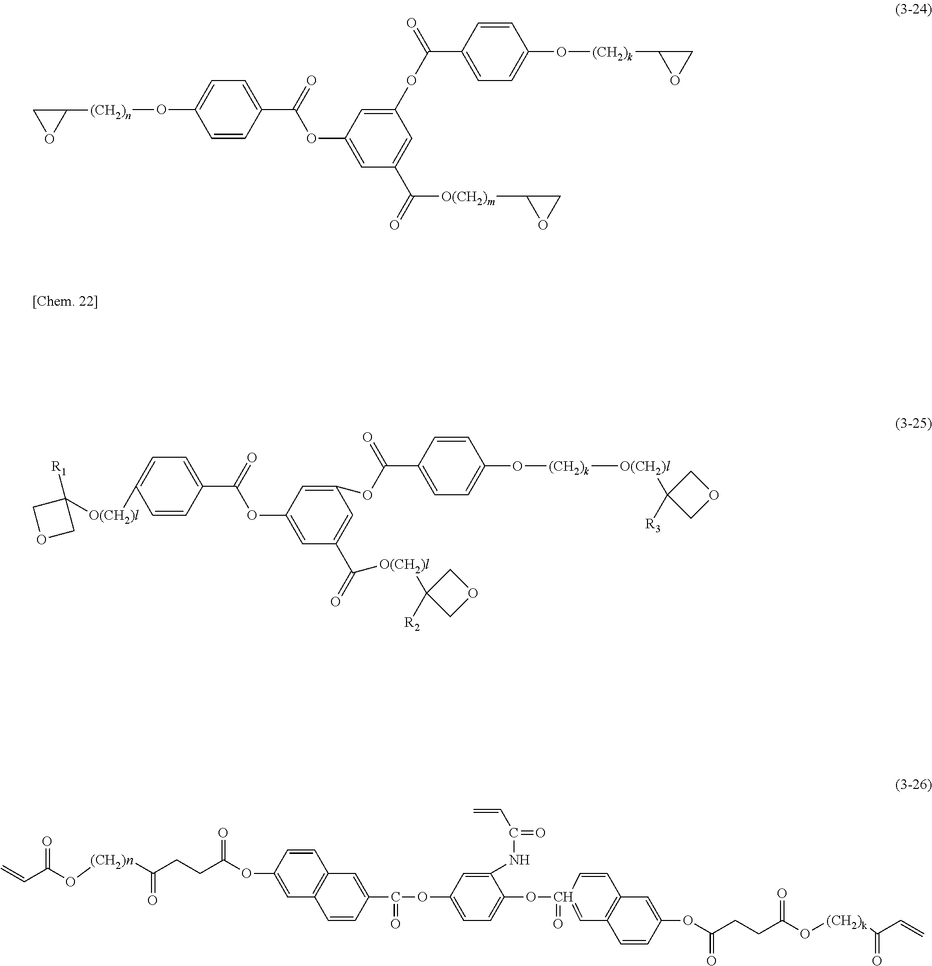

One or more types of liquid crystal compounds having 3 polymerizing functional groups may be used, but 1 to 4 types thereof are preferably used, and 1 to 3 types thereof are more preferably used.

The content of the liquid crystal compound having 3 polymerizing functional groups is preferably 0 to 30% by mass of the polymerizing liquid crystal composition, more preferably 0 to 70% by mass, even more preferably 0 to 60% by mass.

The polymerizing liquid crystal composition in the present invention may further contain a liquid crystal compound having one polymerizing functional group.

Specifically, the liquid crystal compound having one polymerizing functional group is preferably a compound represented by the following general formula (4):

[Chem. 23]

P⁴-(Sp⁴)ₘ₄-MG-R⁴ (4)

In the formula, P⁴ represents a polymerizing functional group, Sp⁴ represents an alkylene group having 0 to 18 carbon atoms (the alkylene group may be substituted with one or more of a halogen atom or CN, and one CH₂ group or 2 or more CH₂ groups not adjacent to each other existing in this group may be each independently replaced with, in the form where oxygen atoms do not directly bond to each other, —O—, —S—, —NH—, —N(CH₃)—, —CO—, —COO—, —OCO—, —OCOO—, —SCO—, —COS— or —C≡C—), m4 represents 0 or 1, MG represents a mesogen group or a mesogenic supporting group,

R⁴ represents a hydrogen atom, a halogen atom, a cyano group, or an alkyl group having 1 to 18 carbon atoms, and the alkyl group may be substituted with one or more of a halogen atom or CN, and one CH₂ group or 2 or more CH₂ groups not adjacent to each other existing in this group may be each independently replaced with, in the form where oxygen atoms do not directly bond to each other, —O—, —S—, —NH—, —N(CH₃)—, —CO—, —COO—, —OCO—, —OCOO—, —SCO—, —COS— or —C≡C—.

P⁴ preferably represents a substituent selected from polymerizing groups represented by the following formulae (P-1) to (P-20):

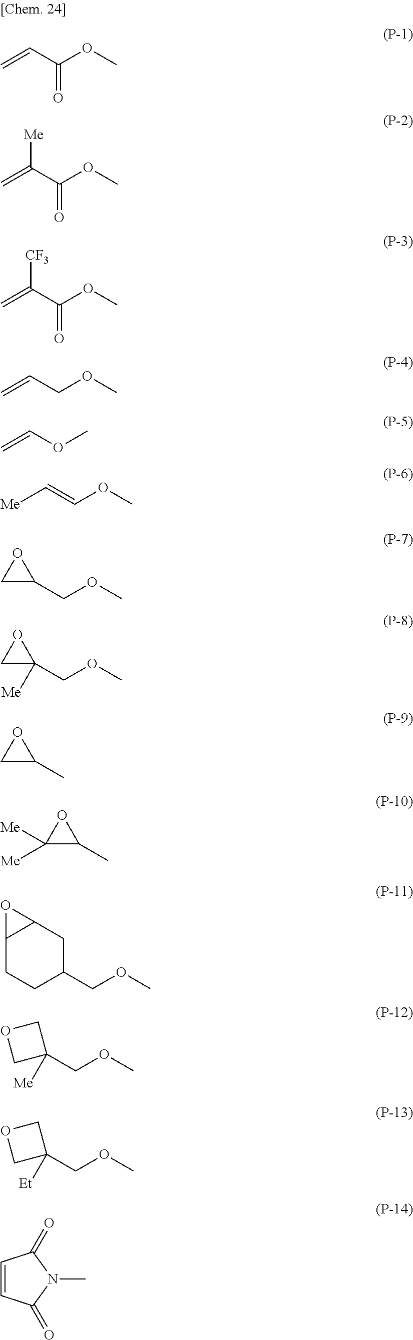

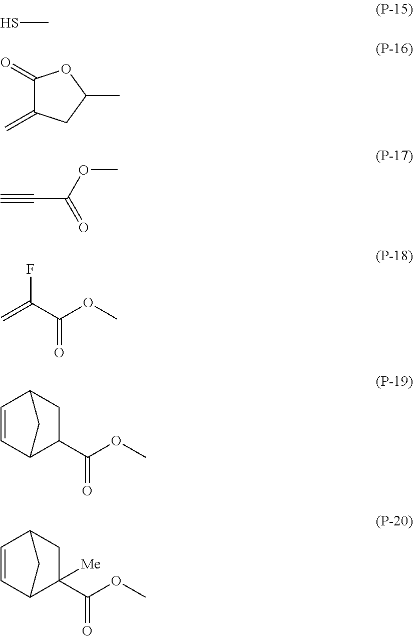

Among these polymerizing functional groups, the formulae (P-1), (P-2), (P-7), (P-12), and (P-13) are preferred from the viewpoint of enhancing polymerization performance and storage stability, and the formulae (P-1), (P-7), and (P-12) are more preferred.

The mesogen group or the mesogenic supporting group represented by MG includes a group represented by a general formula (4-b):

[Chem. 25]

—Z0-(A1-Z1)ₙ₄-(A2-Z2)ₖ₄-(A3-Z3)ₗ₄-A4-Z4-A5-Z5- (4-b)

In the general formula (4-b), A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalane-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; the group may have one or more substituents of F, Cl, CF₃, OCF₃, a CN group, an alkyl group having 1 to 8 carbon atoms, an alkoxy group, an alkanoyl group, an alkanoyloxy group, and an alkenyl group having 2 to 8 carbon atoms; Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond;

n, l and k each independently represent 0 or 1, and 0≦n+l+k≦3.

Examples of the general formula (4) include general formulae (4-1) to (4-4), but are not limited to the following general formulae.

[Chem. 26]

P^{4a}-(Sp^{4a})ₘ₄-Z0-A4-Z4-A5-Z5-(Sp^{4b})ₙ₄-R⁴ (4-1)

P^{4a}-(Sp^{4a})ₘ₄-Z0-A3-Z3-A4-Z4-A5-Z5-(Sp^{4b})ₙ₄-R⁴ (4-2)

P^{4a}-(Sp^{4a})ₘ₄-Z0-A2-Z2-A3-Z3-A4-Z4-A5-Z5-(Sp^{4b})ₙ₄-R⁴ (4-3)

P^{4a}-(Sp^{4a})ₘ₄-Z0-A1-Z1-A2-Z2-A3-Z3-A4-Z4-A5-Z5-(Sp^{4b})ₙ₄-R⁴ (4-4)

In the formulae, A1, A2, A3, A4, and A5 are the same as those defined in the general formula (4-b). Also Z0, Z1, Z2, Z3, Z4, and Z5 are the same as those defined in the general formula (4-b). R⁴ is the same as that in the general formula (4).

P^{4a} represents a polymerizing functional group, Sp^{4a} and Sp^{4b} each independently represent an alkylene group having 0 to 18 carbon atoms (the alkylene group may be substituted with one or more of a halogen atom or CN, and one CH₂ group or 2 or more CH₂ groups not adjacent to each other existing in this group may be each independently replaced with, in the form where oxygen atoms do not directly bond to each other, —O—, —S—, —NH—, —N(CH₃)—, —CO—, —COO—, —OCO—, —OCOO—, —SCO—, —COS— or —C≡C—). m4 and n4 each independently represent 0 or 1.

The compound represented by the general formula (4) includes compounds represented by the following formulae (4-5) to (4-41), but is not limited thereto.

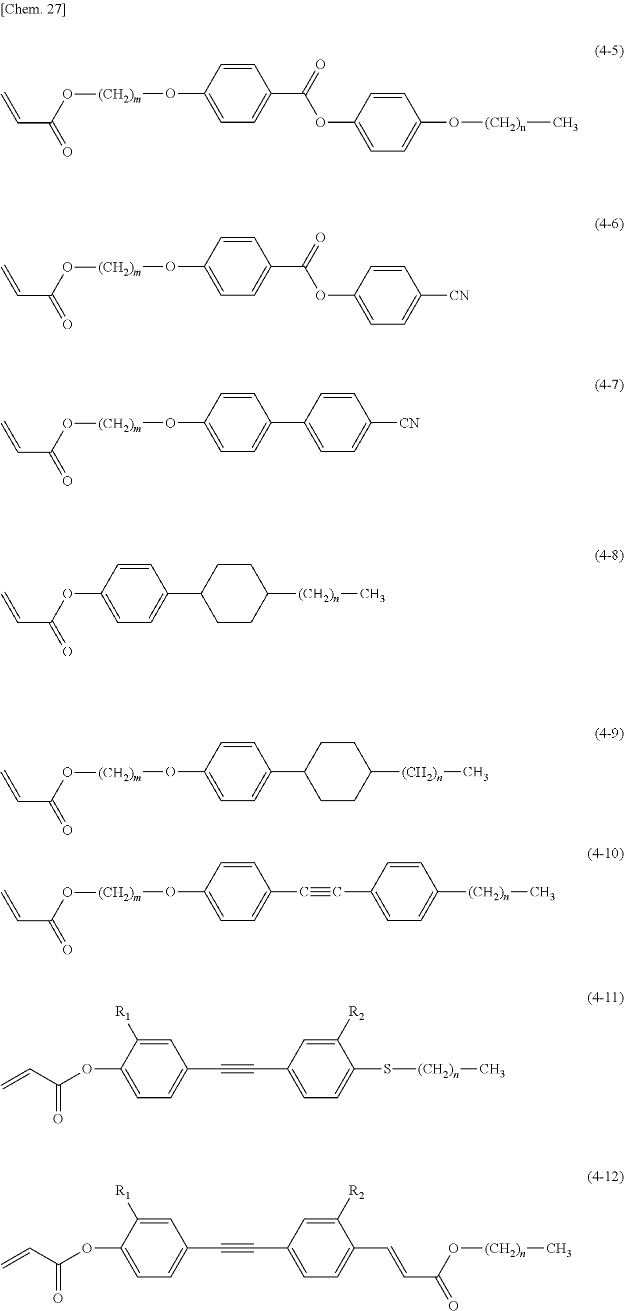

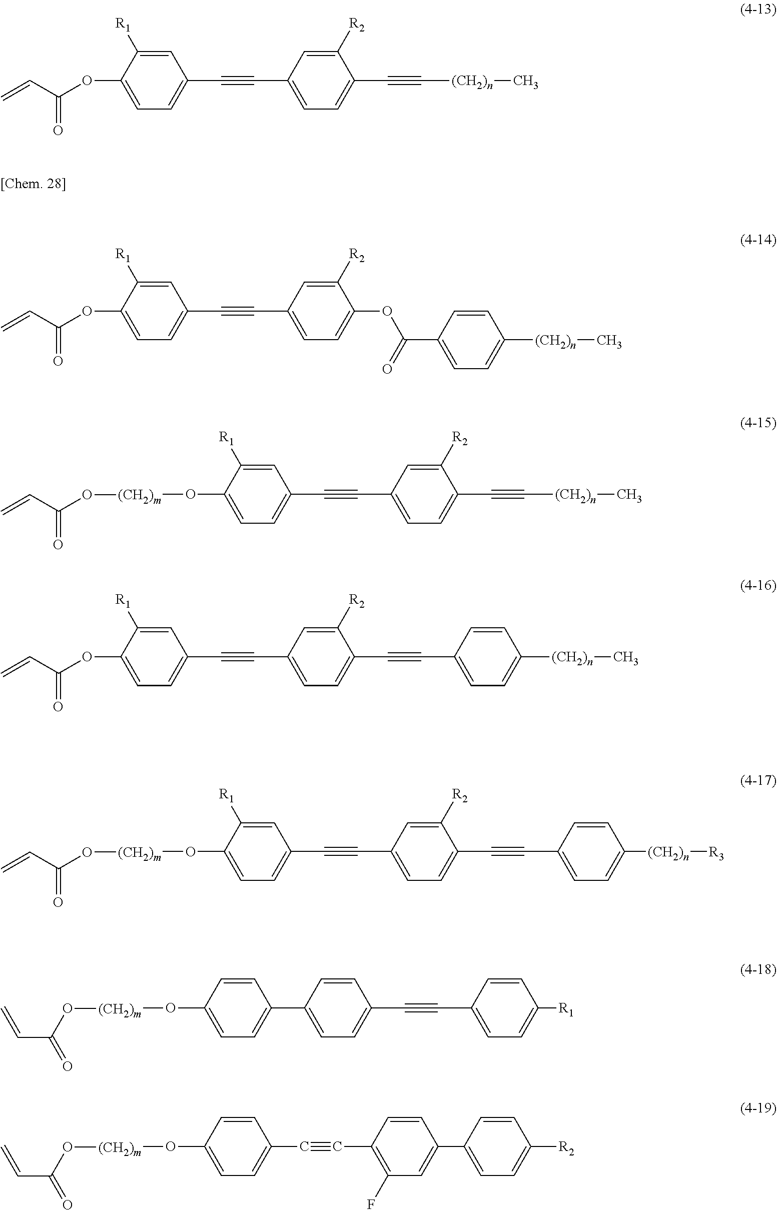

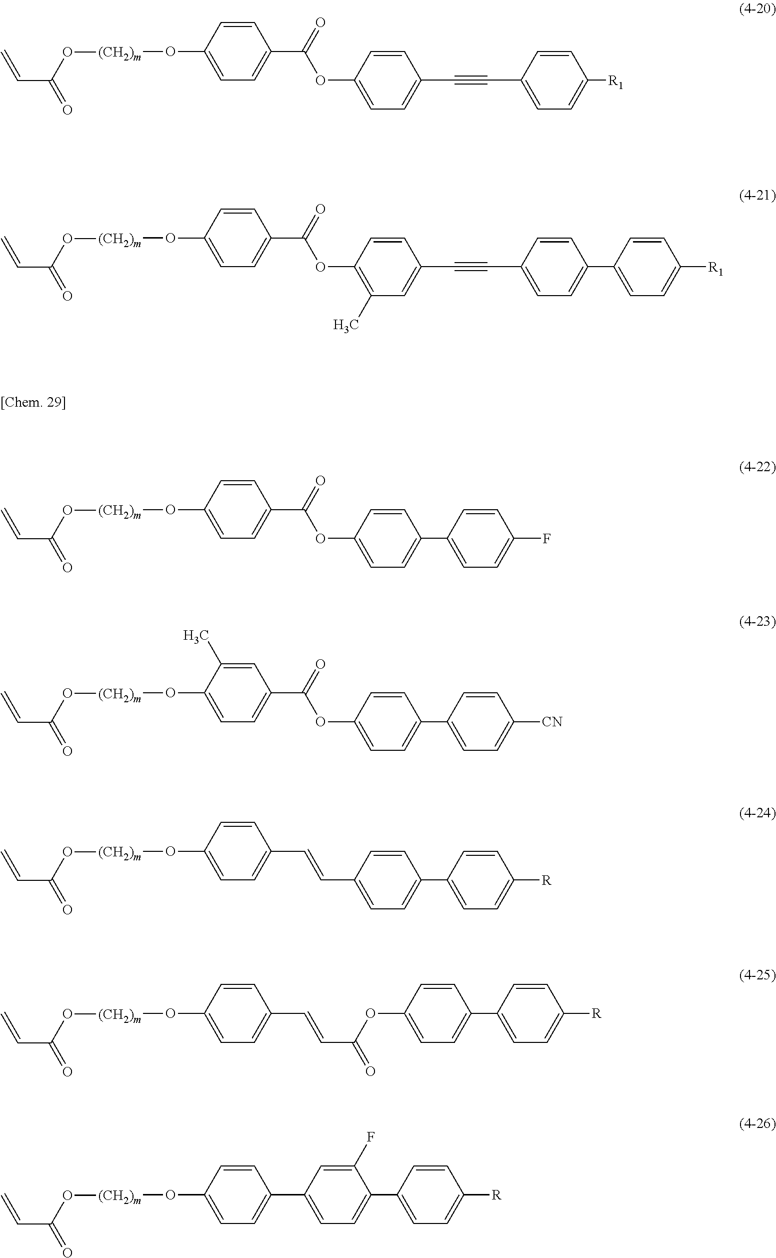

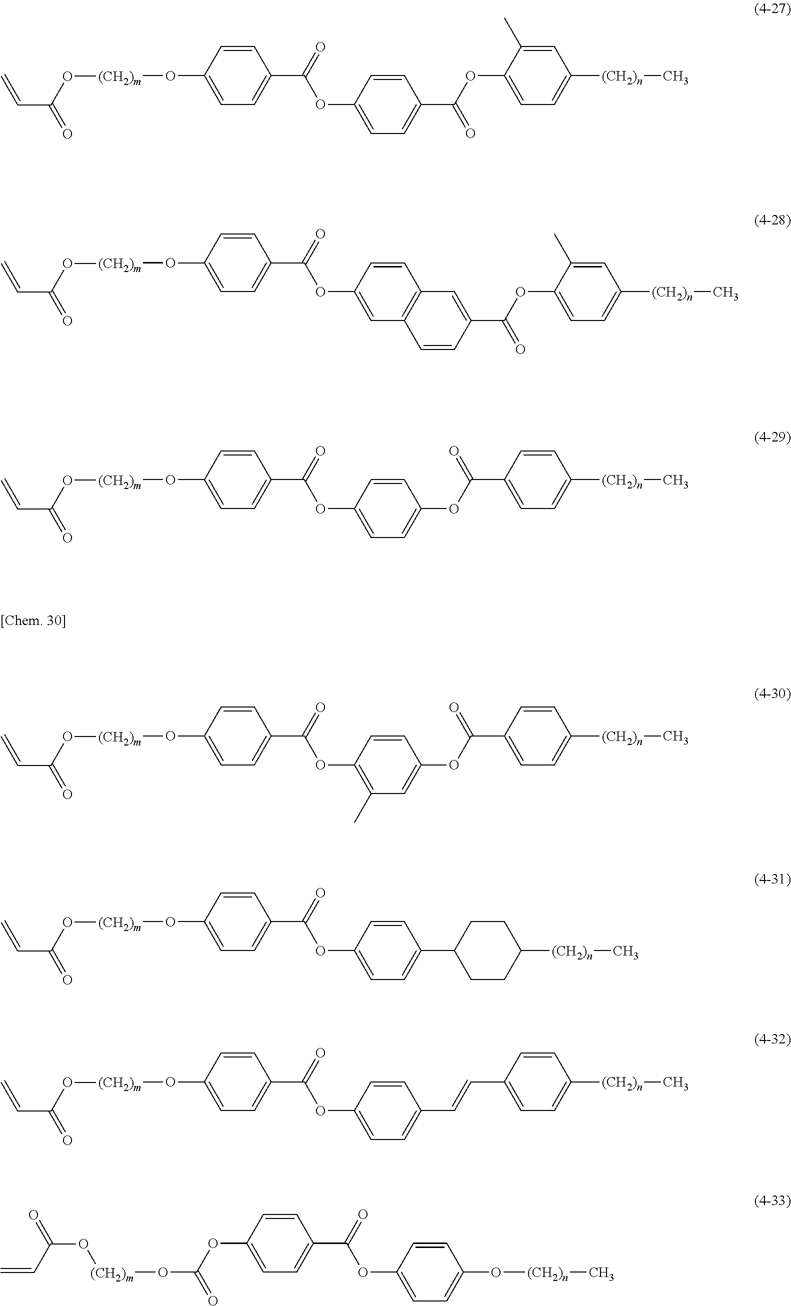

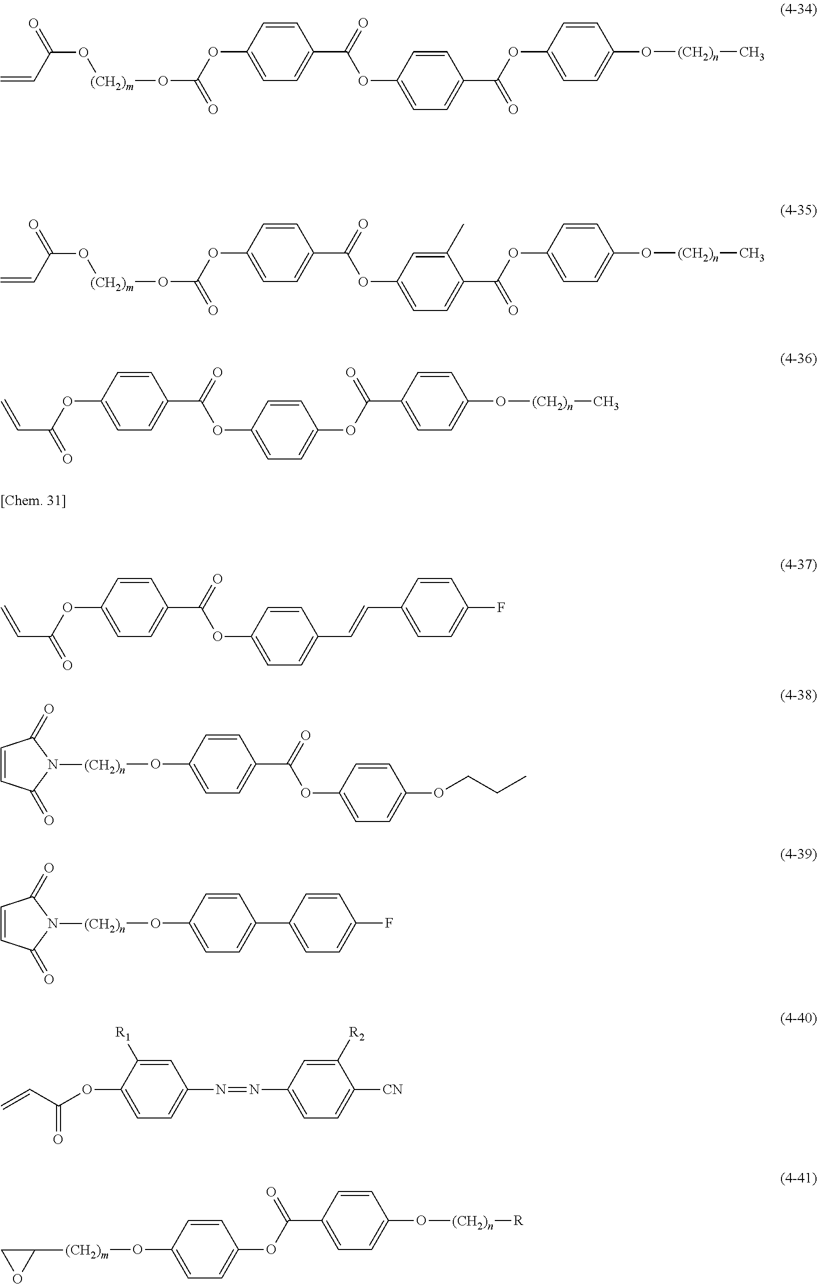

In the formulae, m and n each independently represent an integer of 1 to 18, R, R₁ and R₂ each independently represent a hydrogen atom, an alkyl group having 1 to 6 carbon atoms, an alkoxy group having 1 to 6 carbon atoms, a carboxyl group or a cyano group, and in the case where these groups are an alkyl group having 1 to 6 carbon atoms or an alkoxy group having 1 to 6 carbon atoms, they all are unsubstituted or any of them may be substituted with one or more halogen atoms.

One or more types of liquid crystal compounds having one polymerizing functional group may be used, but 1 to 5 types thereof are preferably used, and 1 to 4 types thereof are more preferably used. The content of the liquid crystal compound having one polymerizing functional group is preferably 0% by mass or more of the polymerizing liquid crystal composition, more preferably 10% by mass or more, even more preferably 20% by mass or more, and is preferably 75% by mass or less, more preferably 70% by mass or less, even more preferably 65% by mass or less.

In the present invention, polymerization of the polymerizing liquid crystal composition can be carried out according to a known method, and in general, it is desirable that the polymerization is carried out through photoirradiation with UV rays or the like or by heating while the polymerizing liquid crystal compound in the composition is kept aligned. In the case where the polymerization is carried out through photoirradiation, concretely, it is desirable that the composition is irradiated with UV rays of 390 nm or shorter and most preferably with light having a wavelength of 250 to 370 nm. However, in the case where the polymerizing compound may be decomposed by UV rays of 390 nm or shorter, the composition may be preferably polymerized with UV rays of 390 nm or longer as the case may be. The light is preferably a diffusive light and is an unpolarized light. As the polymerization initiator and other additives for use in the polymerization, any known ones are usable.

The method for polymerizing the polymerizing liquid crystal composition in the present invention includes a method of irradiation with active energy rays or a thermal polymerization method, and a method of irradiation with active energy rays is preferred since it does not require heating and the reaction therein can run on at room temperature. Above ail, a method of irradiation with at least one type of light selected from a group consisting of UV rays, electron beams (EB) and alpha rays is preferred, since the operation thereof is simple. The temperature in irradiation is a temperature at which the polymerizing liquid crystal composition in the present invention can keep a liquid crystal phase, and for preventing induction of thermal polymerization of the polymerizing liquid crystal composition, the temperature is preferably and where possible 30° C or lower. In general, in a heating process, a liquid crystal composition shows a liquid crystal phase in a range of C (solid phase)-N (nematic) transition temperature (hereinafter this is abbreviated as C-N transition temperature) to N-I transition temperature. On the other hand, in a cooling process, a liquid crystal composition takes a thermodynamically non-equilibrium state, and therefore as the case may be, it does not solidify even at the C-N transition temperature or lower and may keep a liquid crystal state. This state is referred to as a supercooled state. In the present invention, the liquid crystal composition in a supercooled state is also contained in the state that maintains a liquid crystal phase. Specifically, UV rays of 390 nm or shorter are preferably used for irradiation, and most preferably, those having a wavelength of 250 to 370 nm are used. However, in the case where the polymerizing composition may be decomposed by UV rays of 390 nm or shorter, the polymerization may be preferably carried out with UV rays of 390 nm or longer as the case may be. The light is preferably a diffusive light and is an unpolarized light. The UV irradiation intensity is preferably within a range of 0.05 kW/m² to 10 kW/m². More preferably, the intensity is within a range of 0.2 kW/m² to 2 kW/m². When the UV intensity is less than 0.05 kW/m², a lot of time will be taken for completing the polymerization. On the other hand, at an intensity of more than 2 kW/m², the liquid crystal molecules in the polymerizing liquid crystal composition may tend to photodecompose or much polymerization heat may be generated to increase the temperature during the polymerization with the result that the order parameter of the polymerizing liquid crystal may be thereby changed to provide a possibility that the retardation of the film after polymerization may be out of order.

When a specific part alone is polymerized through UV irradiation using a mask, and then the alignment state of the unpolymerized part is changed by applying thereto an electric field, a magnetic field or heating and thereafter the unpolymerized part is polymerized, then an optically-anisotropic body having plural regions differing in the alignment direction may be obtained.

In addition, in polymerizing a specific part alone though UV irradiation using a mask, when the alignment of the polymerizing liquid crystal composition in the unpolymerized state is controlled by applying thereto an electric field, a magnetic field or heating in advance, and when the composition is polymerized through irradiation with light from above the mask while the state is kept as such, then an optically-anisotropic body having plural regions differing in the alignment direction may also be obtained.

As the solvent for use in the polymerizing liquid crystal composition, solvents in which the above-mentioned compounds exhibit good solubility can be used, though not specifically limited thereto. Examples of the solvent include aromatic hydrocarbons such as toluene, xylene, mesitylene, etc.; ester solvents such as methyl acetate, ethyl acetate, propyl acetate, etc.; ketone solvents such as methyl ethyl ketone, methyl isobutyl ketone, cyclohexanone, etc.; ether solvents such as tetrahydrofuran, 1,2-dimethoxyethane, anisole, etc.; amide solvents such as N,N-dimethylformamide, N-methyl-2-pyrrolidone, etc.; γ-butyrolactone, chlorobenzene, etc. One alone or two or more of these may be used either singly or as combined. In addition, additives may be added.

As needed, a liquid crystal compound not having a polymerizing group may be added to the polymerizing liquid crystal composition. However, when the amount thereof added is too much, the liquid crystal compound may dissolve out from the resultant optically-anisotropic body to contaminate the layered member and, in addition, the heat resistance of the optically-anisotropic body worsens, and therefore in adding the compound, its amount is preferably 30% by mass or less of the total amount of the polymerizing liquid crystal compound, more preferably 15% by mass or less, even more preferably 5% by mass or less.

A compound that is not a polymerizing liquid crystal compound though having a polymerizing group may be added to the polymerizing liquid crystal composition. With no specific limitation, the compound of the type may be any one that can be generally recognized as a polymerizing monomer or a polymerizing oligomer in the technical field of the art. In adding the compound, its amount is preferably 5% by mass or less of the polymerizing liquid crystal composition in the present invention, more preferably 3% by mass or less.

An optically active compound, that is, a chiral compound may be added to the polymerizing liquid crystal composition. The chiral compound does not need to exhibit a liquid crystal phase by itself, and may have or may not have a polymerizing group. The helical direction of the chiral compound may be adequately selected depending on the intended use of the polymer.

Specifically, for example, the chiral compound includes pelargonic acid cholesterol ester and stearic acid cholesterol ester having a cholesteryl group as a chiral group; “CB-15” and “C-15” manufactured by BDH Chemicals Corporation, “S-1082” manufactured by Merck & Co., and “CM-19”, “CM-20” and “CM” manufactured by Chisso Corporation, all having a 2-methylbutyl group as a chiral group; “S-811” manufactured by Merck & Co., and “CM-21” and “CM-22” manufactured by Chisso Corporation, all having a 1-methylheptyl group as a chiral group, etc.

In adding a chiral compound, the amount thereof is, though depending on the use of the polymer of the polymerizing liquid crystal composition, preferably so controlled that the value to be calculated by dividing the thickness (d) of the resultant polymer by the helical pitch (P) in the polymer (d/P) could fall within a range of 0.1 to 100, more preferably within a range of 0.1 to 20.

A stabilizer may be added to the polymerizing liquid crystal composition for enhancing the storage stability of the composition. The stabilizer includes, for example, hydroquinone, hydroquinone monoalkyl ethers, tert-butyl catechols, pyrogallols, thiophenols, nitro compounds, β-naphthylamines, β-naphthols, etc. When a stabilizer is added, the amount thereof is preferably 1% by mass or less of the polymerizing liquid crystal composition in the present invention, more preferably 0.5% by mass or less.

In the case where the polymer and the optically-anisotropic body obtained from the polymerizing liquid crystal composition are used, for example, as a material for optical members such as retardation films, polarization films, etc., or for use in printing ink, coating material, protective films, etc., a metal, a metal complex, a dye, a pigment, a fluorescent material, a phosphorescent material, a surfactant, a leveling agent, a thixotropic agent, a gelling agent, a polysaccharide, a UV absorbent, an IR absorbent, an antioxidant, an ion-exchange resin, a metal oxide such as titanium oxide and the like may be added to the polymerizing liquid crystal composition, depending on the object of thereof.

By applying the polymerizing liquid crystal composition in the present invention onto a substrate having an alignment function, then uniformly aligning the liquid crystal molecules in the polymerizing liquid crystal composition in the present invention while the smectic phase and the nematic phase thereof are kept as such, and polymerizing them, the optically-anisotropic body of the present invention can be obtained.

To the retardation layer in the present invention, various alignment modes are applicable with no specific limitation so far as they can improve the viewing angle dependence to be influenced by birefringence characteristics that liquid crystal molecules have. For example, alignment modes of a positive A plate, a negative A plate, a positive C plate, a negative C plate, a biaxial plate, a positive O plate and a negative O plate are applicable. Above all, use of a positive A plate and a negative C plate is preferred. Further, layering a positive A plate and a negative C plate is more preferred for use herein.

Here, the positive A plate means an optically-anisotropic body where a polymerizing liquid crystal composition is homogeneously aligned. The negative C plate means an optically-anisotropic body where a polymerizing liquid crystal composition is cholesteric-aligned.

In a liquid crystal cell of one embodiment of the present invention, if is desirable to use a positive A plate as the first retardation layer for the purpose of broadening the viewing angle by compensating the viewing angle dependence with polarization axis orthogonality. Here, the positive A plate satisfies a relation of “nx>ny=nz” where nx indicates the refractive index in the in-plane slow axis direction of the film, ny indicates the refractive index in the in-plane fast axis direction of the film, and nz indicates the refractive index in the thickness direction of the film. The positive A plate is preferably one whose in-plane retardation at a wavelength of 550 nm falls within a range of 30 to 500 nm. The thickness direction retardation thereof is not specifically limited. The Nz coefficient is preferably within a range of 0.9 to 1.1.

For cancelling the birefringence of liquid crystal molecules themselves, it is desirable to use a so-called negative C plate having negative refractive index anisotropy as a second retardation layer. A negative C plate may be layered on a positive A plate.

Here, the negative C plate is a retardation layer that satisfies a relation of “nx=ny>nz” where nx indicates the refractive index in the in-plane slow axis direction of the retardation layer, ny indicates the refractive index in the in-plane fast axis direction of the retardation layer, and nz indicates the refractive index in the thickness direction of the retardation layer. The thickness direction retardation of the negative C plate preferably falls within a range of 20 to 400 nm.

The refractive index anisotropy in the thickness direction is represented by the thickness direction retardation Rth defined by the formula (2). The thickness direction retardation Rth can be calculated as follows: Using the in-plane retardation R₀, the retardation R₅₀ measured by tilting the slow axis by 50° as an inclined axis, the film thickness d and the mean refractive index of the film n₀, and through numerical calculation according to the formula (1) and the following formulae (4) to (7), nx, ny and nz are calculated, and these are assigned to the formula (2) to calculate Rth. In addition, the Nz coefficient can be calculated from the formula (3). The same shall apply to the other parts in this description.

R₀=(nx−ny)×d (1)

Rth=[(nx+ny)/2−nz]×d (2)

Nz coefficient=(nx−nz)/(nx−ny) (3)

R₅₀=(nx−ny′)×d/cos(φ) (4)

(nx+ny+nz)/3=n0 (5)

wherein:

φ=sin⁻¹[sin(50°)/n₀] (6)

ny′=ny×nz/[ny²×sin²(φ)+nz²×cos²(φ)]^{1/2} (7)

In many commercially-available retardation measurement devices, the numerical calculation shown herein is automatically carried out to automatically express the in-plane retardation R₀ and the thickness-direction retardation Rth. One example of such measurement devices is PETS-100 (manufactured by Otsuka Chemical Co., Ltd.).

In the present invention, in practical use of an optical film, for example, an optical film using the above-mentioned polymerizable liquid crystal material, it is desirable that the substrate and the alignment film do not peel with ease from each other. Up to now, for improving adhesion to a substrate, a structural unit having a function of enhancing adhesion performance has been incorporated into the alignment film material, for example, by copolymerizing the material with a structural unit having an alignment function, but in such a case, the alignment function has been sacrificed. The repeating structure of an alignment material having a specific structure, which is one characteristic feature of the present invention, exhibits an excellent effect for improving adhesion to an acrylic resin. Accordingly, the alignment film using photo-responsive molecules as an alignment material in the present invention has excellent adhesion to an acrylic resin, and this is also another advantageous effect of the present invention. Specifically, by combination of the alignment material having a specific structure and the acrylic resin substrate, the present invention can exhibit the advantageous effect thereof and can provide a practicable optical film. Further, the case where the acrylic resin of the substrate is a polymethyl methacrylate enjoys the effect of the present invention, and in particular, the case where the alignment material has a cinnamic acid derivative structure in the structure thereof can more advantageously enjoy the effect of the present invention, the case where the cinnamic acid derivative structure is a cinnamic acid structure can even more advantageously enjoy the effect of the present invention. The cinnamic acid structure is preferably one having a 1-carboxylethen-2-yl group at the terminal. In the case where the substrate is an inexpensive acrylic resin, especially where it is PMMA, an optical film can be constructed inexpensively.

Consequently, a preferred embodiment of the layered body of the present invention is produced by applying a solution that contains at least an alcohol solvent and a compound having a repeating unit represented by the following formula (2):

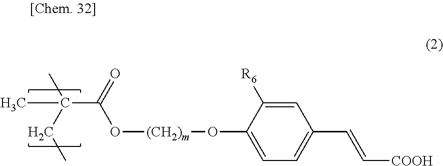

(In the above general formula (2), R⁶ represents a hydrogen atom or a methoxy group, and m represents an integer of 2 to 20), onto a transparent substrate containing an acrylic resin, and drying it thereon and then irradiating it with polarizing UV rays to thereby spread and bond the layer on the transparent substrate.

A preferred embodiment of the optical film of the present invention has a layer formed by polymerizing a composition containing a polymerizable liquid crystal material, on a photo-alignment layer formed by applying a solution that contains at least an alcohol solvent and a compound having a repeating unit represented by the following formula (2):

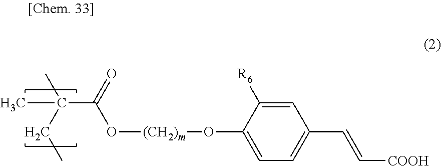

(In the above general formula (2), R⁶ represents a hydrogen atom or a methoxy group, and m represents an integer of 2 to 20), onto a transparent substrate containing an acrylic resin, and drying if thereon and then irradiating it with polarizing UV rays to thereby spread and bond the layer on the transparent substrate.

The alcohol solvent is preferably methoxyethanol, ethyl cellosolve, propyl cellosolve or butyl cellosolve, and methoxyethanol is especially preferred.

A production method for the layered body of the present invention and a production method for the optical film of the present invention are described below.

### [Preparation of Photo-Responsive Molecules and Formation of Photo-Alignment Layer]

As a method for forming a photo-alignment layer containing photo-responsive molecules capable of responding to light in such a manner that the layer could spread and bond (or adhere) to at least one surface of a transparent substrate containing an acrylic resin, for example, there are mentioned a method of applying a solution containing photo-responsive molecules onto a transparent substrate containing an acrylic resin, and then drying it to form a layered body (this may be referred to as method 1), and a method of applying a solution containing a precursor of photo-responsive molecules onto a transparent substrate containing an acrylic resin, and then a photo-alignment layer is formed on the transparent substrate through chemical reaction of the precursor of photo-responsive molecules (this may be referred to as method 2). These methods may include, as needed, a drying step of removing the solvent, and in these methods, the coating operation may be repeated plural times or the step of forming the layered body may be repeated plural times until the photo-alignment layer could reach a predetermined thickness.

Preparation of the photo-responsive molecules for use in the present invention is described below. In the case where a polymer is used to give photo-responsive molecules in the present invention, preferably, a monomer to give a repeating unit represented by the following chemical formula (3) is used to provide a compound having a photochemically crosslinkable site.

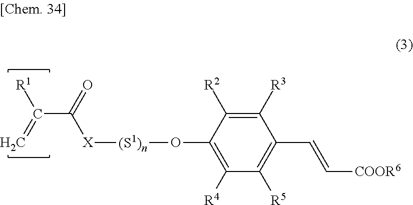

(In the above general formula (3), R¹ represents a hydrogen atom or a methyl group, R², R³, R⁴ and R⁵ each independently represent a hydrogen atom, a fluorine atom, an alkyl group having 1 to 6 carbon atoms or an alkoxy group, R⁶ represents a hydrogen atom, or an alkyl group having 1 to 6 carbon atoms which may be substituted with a cyano group or an alkoxy group having 1 to 3 carbon atoms, X represents —O— or —NH—, S¹ represents —O— or a methylene group which may be substituted with an alkyl group having 1 to 3 carbon atoms and/or a fluorine atom, provided that the oxygen atoms existing in the above general formula (1) are not adjacent to each other, and n represents an integer of 2 to 20.)

The alignment material having a specific structure as one characteristic feature of the present invention has a specific repeating structure as described above, in which the structure may not be a simple structure but may be formed of plural specific structures. For obtaining the alignment material of the type, plural types of monomers shown by the above general formula (3) may be polymerized.

In preparing the polymer of this embodiment, a polymerization initiator may be optionally used in accordance with the polymerization mode of the polymerizing functional group, and examples of the polymerization initiator are known in Synthesis and Reaction of Polymer (edited by the Society of Polymer Science, Japan, published by Kyoritsu Publishing), etc.

Examples of the thermal polymerization initiator in radical polymerization include azo compounds such as azobisisobutyronitrile, 2,2′-azobis(2,4-dimethylvaleronitrile), etc.; peroxides such as t-butyl hydroperoxide, benzoyl peroxide, etc.

Examples of the photopolymerization initiator include aromatic ketone compounds such as benzophenone, Michler's ketone, xanthone, thioxanthone, etc.; quinone compounds such as 2-ethylanthraquinone, etc.; acetophenone compounds such as acetophenone, trichloroacetophenone, 2-hydroxy-2-methylpropiophenone, 1-hydroxycyclohexyl phenyl ketone, benzoin ether, 2,2-diethoxyacetophenone, 2,2-dimethoxy-2-phenylacetophenone, etc.; diketone compounds such as benzil, methylbenzoyl formate, etc.; acyloxime ester-compounds such as 1-phenyl-1,2-propanedione-2-(o-benzoyl) oxime, etc.; acylphosphine oxide compounds such as 2,4,6-trimethylbenzoyldiphenyl phosphine oxide, etc.; sulfur compounds such as tetramethylthiuram, dithiocarbamate, etc.; organic peroxides such as benzoyl peroxide, etc.; azo compounds such as azobisisobutyronitrile, etc. The thermal polymerization initiator in cationic polymerization includes aromatic sulfonium compounds, etc. The photopolymerization initiator includes organic sulfonium salt compounds, iodonium salt compounds, phosphonium compounds, etc.

The amount of the polymerization initiator to be added is preferably 0.1 to 10% by mass, more preferably 0.1 to 6% by mass, even more preferably 0.1 to 3% by mass. Addition reaction to the polymer main chain such as that for a polysiloxane compound may synthesize the intended polymer.

The photo-responsive molecules of the general formula (1), as one characteristic feature of the present invention, have one or a plurality of the above-mentioned specific repeating units and, in addition, may have any other structural unit as incorporated therein in accordance with the intended object for improving leveling performance, improving adhesion, improving scratch resistance, improving heat resistance, improving lightproofness, etc. For this, the monomer represented by the above general formula (3) maybe polymerized or copolymerized with any other monomer in accordance with the intended object, arid such polymerization includes heretofore-known copolymerization such as random copolymerization, block copolymerization, etc. In such a case, compositional ratio of the specific repeating structure that is one characteristic feature of the present invention to the other structural unit may be adequately selected within a range not detracting from the advantageous effects of the present invention. Preferably, the ratio of “specific repeating structure in the present invention”/“other repeating structure” is 20/80 to 99.1/0.1, more preferably 50/50 to 99.5/0.5, even more preferably 70/30 to 99/1. Examples of the monomer to be used in incorporating the other repeating structure include styrene, acrylic acid, methacrylic acid, 2-hydroxyethyl acrylate, 2-hydroxyethyl methacrylate, glycidyl methacrylate, methyl methacrylate, ethyl methacrylate, butyl methacrylate, etc.

In arranging the alignment material having a specific structure that is one characteristic feature of the present invention, on a substrate, for example, the alignment material may be dissolved in a suitable solvent and the resultant coating solution may be applied onto a substrate and dried thereon. Alternatively, a monomer of the above-mentioned general formula (3) may be dissolved in a suitable solvent, then the resultant coating solution may be applied onto a substrate and subjected to polymerization by heat or light, and in this case, a suitable amount of the above-mentioned radical initiator or the like may be mixed in the coating solution.

The polymer of this embodiment may be obtained by polymerization in a glass or stainless reactor in advance followed by purification of the formed polymer. The polymerization may be carried out by dissolving a monomer to be a starting material in a solvent, and preferred examples of the solvent include benzene, toluene, xylene, ethylbenzene, pentane, hexane, heptane, octane, cyclohexane, cycloheptane, methanol, ethanol, 1-propanol, 2-propanol, ethylene glycol, ethylene glycol monomethyl ether, ethylene glycol dimethyl ether, 2-butanone, acetone, tetrahydrofuran, γ-butyrolactone, N-methyl-pyrrolidone, dimethylsulfoxide, dimethylformamide, etc. Two or more types of organic solvents may be used as combined.

### (Method 1)

Photoirradiation of a coating film formed of the above-mentioned photo-responsive molecules provides a photo-alignment layer (film) given alignment control performance for liquid crystal molecules and given stability to heat, and light for liquid crystal molecule alignment. Preferably, the photo-alignment layer in the present invention is formed according to a coating method of applying a solution containing photo-responsive molecules onto a substrate containing an acrylic resin.

A solution that contains photo-responsive molecules in the present invention is applied onto at least one surface of a tabular or filmy acrylic resin substrate to give a layered body, and the coating layer of the solution is dried to remove the solvent form the solution layer, thereby giving a layered body that has a dry coating film as formed by drying photo-responsive molecules on at least one surface of the acrylic resin substrate. By irradiating the dry coating film that contains photo-responsive molecules with polarized light, there can be formed a photo-alignment film having an alignment controlling ability relative to liquid crystal molecules and capable of giving stability to heat and light for alignment of liquid crystal molecules. In other words, by irradiating the layered body having the dry coating film with polarized light, a layered body having the above-mentioned photo-alignment film can be obtained.

The solution containing photo-responsive molecules in the present invention may contain an amine in addition to photo-responsive molecules and a solvent, as described above. Adding an amine may improve the solubility of the polymer component, as the case may be. For example, even in the case where the solvent could hardly dissolve a component of photo-responsive molecules, the component of photo-responsive molecules could be dissolved by adding an amine.

Regarding the amine, in the case where a polymer containing a repeating unit represented by the general formula (1) is selected for the component of photo-responsive molecules, an amine capable of forming a salt with the terminal group —COOR⁶ (carboxylic acid, etc.) such as a carboxyl group or the like that the side chain of the polymer has, or capable of forming interaction therewith is preferred. Examples of preferred amines include primary amines such as ethylamine, propylamine, butylamine, etc.; secondary amines such as diethylamine, dipropylamine, diisopropylamine, dibutylamine, etc.; tertiary amines such as triethylamine, tributylamine, N-ethyl-diisopropylamine, etc. More preferably, the amine is liquid at room temperature. The amount of the amine to be used may be selected adequately, but is preferably 0.01 to 2.0% by weight relative to the main solvent.

As the solvent to constitute the solution for forming a photo-alignment layer in the present invention, one alone or two or more types of solvents may be used either singly or as combined.

Preferred examples of the solvent include glycol ethers such as 2-methoxyethanol, 2-ethoxyethanol, 1-methoxy-2-propanol, 1-ethoxy-2-propanol, etc.; cellosolves such as ethyl cellosolve, propyl cellosolve, butyl cellosolve, etc.; and a solvent that contains a single solvent selected from methoxyethanol, ethyl cellosolve, propyl cellosolve and butyl cellosolve or a mixed solvent composed of the plural solvents selected therefrom as a component having a highest weight ratio is also preferred. Such preferred solvents hardly corrode acrylic resin substrates.

Preferred examples of the mixed solvent include, for example, a mixed solvent of 2-methoxyethanol and 2-ethoxyethanol, and a mixed solvent of 2-methoxyethanol and isopropyl alcohol (IPA).

The blending ratio in the mixed solvent of 2-methoxyethanol and 2-ethoxyethanol is preferably 2-mehtoxyethanol/2-ethoxyethanol=10/90 to 90/10 (ratio by mass), more preferably 20/80 to 80/20 (ratio by mass), even more preferably 30/70 to 70/30 (ratio by mass). The blending ratio in the mixed solvent of 2-methoxyethanol and IPA is preferably 2-methoxyethanol/IPA=10/90 to 90/10 (ratio by mass), more preferably 20/80 to 80/20 (ratio by mass), even more preferably 30/70 to 70/30 (ratio by mass).

The method of applying the solution for forming a photo-alignment layer onto an acrylic resin substrate in the present invention includes, for example, methods of spin coating, die coating, gravure coating, flexographic printing, inkjet printing, etc.

The solid concentration in the solution that contains photo-responsive molecules in coating therewith is preferably 0.5 to 10% by mass, and more preferably, in consideration of the method of applying the photo-responsive molecules-containing solution onto an acrylic resin substrate and in consideration of the viscosity of the polymer solution and the volatility of the solvent to constitute the polymer solution, the concentration is selected from the range.

As the method of drying the solution layer formed of the coating solution, a method of heating the coated surface to remove the solvent is preferred. The heating temperature in drying is not specifically limited so far as the acrylic resin substrate would not be damaged or deformed at the temperature, and is preferably 40 to 100° C, more preferably 50 to 80° C. The heating time at the preferred heating temperature is preferably 2 to 200 minutes, more preferably 2 to 100 minutes. The drying method is not specifically limited, including, for example, methods of spontaneous drying, drying by heating, drying under reduced pressure, drying by heating under reduced pressure, etc.

Next, the coating film that has been formed according to the above-mentioned method is photo-crosslinked and cured through linearly-polarized light irradiation in the normal direction to the coating surface or through unpolarized light or linearly-polarized light irradiation in an oblique direction thereto, whereby the coating film comes to express an alignment controlling ability. Different types of irradiation methods may be combined.

As the irradiation light for changing the dry coating film into a photo-alignment by curing (photo-crosslinking reaction) thereof, for example, UV rays and visible light including light having a wavelength of 150 nm to 800 nm can be used. Among these, UV rays of 270 nm to 450 nm are especially preferred.

The light source includes, for example, a xenon lamp, a high-pressure mercury lamp, an ultrahigh-pressure mercury lamp, a metal halide lamp, etc. Relative to the light from the light source, a polarization filter or a polarization prism may be used to give a linearly-polarized light.

The UV rays and visible light from those light sources can be processed to have a controlled irradiation wavelength range using an interference filter, a color filter, etc. The irradiation energy is preferably 1 to 15 mJ/cm² to 500 mJ/cm², more preferably 2 to 20 mJ/cm² to 300 mJ/cm². The lighting intensity is preferably 2 to 500 mW/cm², more preferably 5 to 300 mW/cm².

The amount of the polymer solution to be applied onto the acrylic substrate is preferably such that the thickness of the solution layer to be formed on the substrate surface could fall within a range of 50 to 30,000 nm, more preferably within a range of 50 to 10,000 nm. The mean thickness of the photo-alignment film to be formed is preferably 10 to 250 nm or so, more preferably 10 to 100 nm or so. For controlling the mean thickness of the photo-alignment film to fall within a range of 10 to 250 nm, the coating may be carried out plural times.

### (Method 2)

The photo-responsive molecules in the present invention may also be formed by dissolving a composition containing the monomer represented by the general formula (3) in a solvent, then applying the solution onto a substrate and removing the solvent by drying, and thereafter subjecting polymerization by heating or photoirradiation (the above-mentioned method 2). In this case, the compound represented by the general formula (3) of an alignment material in the present invention is used in the form of a coating solution prepared by dissolving it in an organic solvent, and for example, in the case where an alignment film is formed on a transparent substrate of PMMA, it is desirable that the organic solvent does not dissolve or corrode PMMA. However, as compared with a substrate of PET, PMMA is poorly resistant to chemicals and is therefore poorly resistant to many organic solvents, and consequently, so many types of organic solvents could not be used substantially. Organic solvents suitable for such use include alcohol solvents, and methoxyethanol, ethyl cellosolve, propyl cellosolve and butyl cellosolve are preferred, and methoxyethanol is especially preferred.

The monomers represented by the general formula (3) and the polymers derived from them in the present invention are practically soluble in a lot of organic solvents, and methoxyethanol, ethyl cellosolve, propyl cellosolve and butyl cellosolve are preferably usable. In particular, they are sufficiently soluble in methoxyethanol. From the above, using PMMA as a substrate along with using the alignment material having a specific structure as one characteristic feature of the present invention as an alignment film material, and using methoxyethanol as the solvent for the alignment film material is a preferred combination arid can enjoy the advantageous effects of the present invention. In particular, in view of solubility and film formability and from alignment performance, using PMMA as a substrate and using a polymer represented by the general formula (1) and having a molecular weight of 10,000 to 100,000 in the present invention as an alignment film material, and further using methoxyethanol as a solvent for the alignment film material is the best combination, and can especially favorably enjoy the advantageous effects of the present invention.

In dissolving photo-responsive molecules or a precursor thereof, a compound represented by the general formula (3) for the alignment material in the present invention, in the above-mentioned solvent, any other auxiliary solvent or additive can be used, as needed, for further bettering the solubility thereof. Examples of such substances include primary amines, secondary amines, tertiary amines, etc., preferably ethyl amine, propylamine, butylamine, diethylamine, dipropylamine, diisopropylamine, dibutylamine, etc. The amount thereof to be used may be adequately selected, and is preferably 0.01 to 2.0% by weight relative to the main solvent.

In the case of the above-mentioned method 2, the method of preparing photo-responsive molecules (for example, the polymer represented by the general formula (1)) from the monomer represented by the general formula (3), and the method of applying the monomer onto a substrate may be the same as those in the method 1.

### [Production Method for Optically-Anisotropic Body]

By applying the above-mentioned polymerizing liquid crystal composition onto the above-mentioned photo-alignment layer (film) followed by polymerizing it in a state where the polymerizing liquid crystal molecules in the polymerizing liquid crystal composition are kept aligned, an optically-anisotropic body can be produced. Here, the optically-anisotropic body means a substance of such that, when light runs through the substance, the optical properties such as light speed, refractive index and absorption differ depending on the running direction. Examples of the optically-anisotropic body include optical components such as a retardation plate, a retardation film, etc.

A production method for the optically-anisotropic body includes, for example, the following steps.

In the first step, the photo-alignment layer mentioned above is formed on an acrylic resin substrate. In the second step, this is irradiated with light having anisotropy to give an alignment controlling ability to the coating film containing the photo-responsive molecules, thereby forming a photo-alignment layer. In the third step, a polymerizing liquid crystal composition film is formed on the photo-alignment film. In the fourth step, the polymerizing liquid crystal composition film is polymerized to form an optically-anisotropic body. In the fourth step in this process, polymerization reaction and crosslinking reaction may be in progress at the same time in the photo-alignment layer. In the production process, the coating film containing photo-responsive molecules is directly irradiated with light, and therefore a photo-alignment film having better liquid crystal alignment performance can be obtained.

Another production method is also employable, as mentioned below. In the first step, a coating film that contains photo-responsive molecules is formed on an acrylic resin substrate. In the second step, a polymerizing liquid crystal composition film is formed on the photo-responsive molecules-containing coating film. In the third step, this is irradiated with light having anisotropy to give an alignment controlling ability to the photo-alignment layer, thereby forming a photo-alignment layer. In the fourth step, the polymerizing liquid crystal composition film is polymerized to form an optically-anisotropic body. In this process, the third step and the fourth step may be in progress at the same time through photoirradiation, and in the process, the number of steps can be reduced.

As the case maybe, a few number of optically-anisotropic bodies may be layered. In the case, the above-mentioned steps may be repeated plural times to form a layered body of optically-anisotropic layers. After the optically-anisotropic layer has been formed on the photo-alignment film, a photo-alignment film and an optically-anisotropic body may be additionally layered on the optically-anisotropic body, or after the optically-anisotropic layer has been formed on the photo-alignment film, an optically-anisotropic body may be additionally layered.

After a specific part alone has been polymerized through UV irradiation using a mask, the alignment state of the unpolymerized part may be changed by applying thereto an electric field, a magnetic field or heat, and thereafter the unpolymerized part may be polymerized to give an optically-anisotropic body having a plurality of regions each having a different alignment direction.

In polymerizing a specific part alone through UV irradiation using a mask, the monomer composition in an unpolymerized state may be previously given an electric field, a magnetic field or heat to control the alignment thereof, and while the state is kept as such, this is further irradiated with light from above the mask for polymerization, whereby an optically-anisotropic body having a plurality of regions each having a different alignment direction can also be obtained.

For stabilizing the solvent resistance and the heat resistance of the resultant optically-anisotropic body, the optically-anisotropic body may be aged by heating. In this case, preferably, the body is heated at a temperature not lower than the glass transition point of the polymerizing liquid crystal composition. In general, it is heated preferably at 50 to 300° C, more preferably at a temperature within a heat resistance temperature of the acrylic resin substrate used.

In the optically-anisotropic body obtained in the above step, the optically-anisotropic layer may be peeled from the substrate and may be used as an optically-anisotropic body by itself, or without being peeled from the substrate, the optically-anisotropic body may be used as such. In particular, this hardly contaminates other members, and is therefore useful when it is used as a substrate to be further layered thereon or is used after attached to any other substrate.

The polymerizing liquid crystal composition is preferably a composition containing the above-mentioned polymerizable liquid crystal material, and the film formed by polymerizing the composition that contains the polymerizable liquid crystal material (also referred to as a polymerizing liquid crystal composition) is preferably an optically-anisotropic layer.

### [Other Formation Methods for Liquid Crystal Alignment Layer]

Through photo-irradiation of photo-responsive molecules in this embodiment (for example, the polymer represented by the general formula (1)), the liquid crystal molecules can be given an alignment controlling ability and stability to neat and light in alignment. Using the above-mentioned photo-responsive molecules, there can be provided a liquid crystal alignment layer for horizontal alignment or vertical alignment mode liquid crystal display devices, and also a horizontal alignment or vertical alignment mode liquid crystal display device containing the liquid crystal alignment layer. An example of the formation method for the liquid crystal alignment layer using the above-mentioned photo-responsive molecules includes a method of dissolving the photo-responsive molecules in a solvent, then applying the resultant solution onto a substrate, and photo-irradiating the coating film to form a liquid crystal alignment layer capable of expressing an alignment controlling ability.

Here, the liquid crystal alignment layer and the above-mentioned photo-alignment film may be layers (films) having the same configuration, or may be layers (films) each having a different configuration. The photo-alignment film can align the polymerizing liquid crystal layered on the photo-alignment film. On the other hand, the liquid crystal alignment layer as referred to herein can align the liquid crystal layer that is driven by a voltage in a liquid crystal cell.

The solvent to be used for dissolving a precursor of the photo-responsive molecules in the present invention (for example, the monomer of the above-mentioned general formula (3)) may be the same solvent as that to be used for dissolving the above-mentioned photo-responsive molecules. Polymer preparation through photo-irradiation and alignment controlling ability expression can be attained at the same time, or preparation of photo-responsive molecules and alignment controlling ability expression may be carried out separately by heating and photo-irradiation as combined, or by using two or more different types of lights each having a different wavelength as combined. Further, in any case of the formation method for an alignment layer of aligning liquid crystal molecules, an additional photo-alignment layer may be further formed on a substrate on which an alignment layer has been previously formed to thereby give an ability to control the alignment direction and the alignment angle by the photo-responsive molecules, to the substrate.

In use in a liquid crystal display device, an electrode layer of Cr, Al, an ITO film formed of In₂O₂—SnO₂, a NESA film formed of SnO₂ or the like may be formed on the substrate, and for patterning the electrode layer, a photoetching method or a method of using a mask in forming an electrode layer may be employed. Further, a color filter layer or the like may be formed on the substrate.

The method for applying the solution containing photo-responsive molecules onto a substrate includes, for example, methods of spin coating, die coating, gravure coating, flexographic printing, inkjet printing, etc.

The solid concentration in the solution to be used for coating is preferably 0.5 to 10% by mass. More preferably, the concentration is selected from the range in consideration of the method of applying the solution onto a substrate and of the viscosity and the volatility of the solution.

After the solution containing photo-responsive molecules has been applied onto a substrate, it is desirable that the coated surface is heated to remove the solvent. Regarding the drying condition, preferably, the temperature is 50 to 300° C., more preferably 80 to 200° C., and the time is preferably 2 to 200 minutes, more preferably 2 to 100 minutes.

In the case where a precursor solution of photo-responsive molecules (for example, the monomer of the above-mentioned general formula (3)) is used, thermal polymerization can be carried out in the heating step to prepare a polymer on the substrate. In this case, preferably, a polymerization initiator is contained in the precursor solution. Alternatively, after the solvent has been removed in the heating step, photo-responsive molecules may be prepared by photopolymerization through irradiation with unpolarized light, or thermal polymerization and photopolymerization may be combined.

In the case of preparing photo-responsive molecules from a precursor thereof through thermal polymerization, the heating temperature is not specifically limited so far as it is enough to attain polymerization. In general, the temperature is 50 to 250° C. or so, more preferably 70 to 200° C. or so. In this case, a polymerization initiator may be or may not be added to the composition.

In the case of preparing photo-responsive molecules in this embodiment through photopolymerization, unpolarized UV rays is preferably used for photoirradiation.

Preferably, a polymerization initiator is contained in the composition.

The irradiation energy of unpolarized UV rays is preferably 20 mJ/cm² to 8 J/cm², more preferably 40 mJ/cm² to 5 J/cm².

The lighting intensity of the unpolarized UV rays is preferably 10 to 1000 mV/cm², more preferably 20 to 500 mV/cm².

Preferably, the irradiation wavelength of unpolarized UV rays has a peak in range of 250 to 450 nm.

Next, the coating film formed according to the above-mentioned method is photo-isomerized or photo-crosslinked through linearly-polarized light irradiation in the normal direction to the coating surface or through unpolarized light or linearly-polarized light irradiation in an oblique direction thereto, whereby the coating film comes to express an alignment controlling ability. Different types of irradiation methods may be combined. For giving a desired pretilt angle to the film, linearly-polarized light irradiation in an oblique direction is preferred. In this description, irradiation in an oblique direction means that the angle between the photoirradiation direction and the substrate surface is 1 degree or more and 89 degrees or less. For use as a liquid crystal alignment layer for vertical alignment, in general, the pretilt angle is preferably 70 to 89.8°. For use as a liquid crystal alignment layer for horizontal alignment, in general, the pretilt angle is preferably 0 to 20°.

As the light with which the coating film is irradiated, for example, UV rays and visible rays including light having a wavelength of 150 nm to 800 nm can be used, and UV rays of 270 nm to 450 nm are especially preferred.

The light source includes, for example, a xenon lamp, a high-pressure mercury lamp, an ultrahigh-pressure mercy lamp, a metal halide lamp, etc. Using a polarizing filter or a polarizing prism for the light from such a light source, linearly-polarized light can be obtained. The UV light and visible light from such light sources can be tailored to have a controlled radiation wavelength range using an interference filter, a color filter, etc.

The photoirradiation energy is preferably 1 mJ/cm² to 500 mJ/cm², more preferably 2 mJ/cm² to 300 mJ/cm².

The lighting intensity is more preferably 2 to 500 mW/cm², even more preferably 5 to 300 mW/cm².

The thickness of the liquid crystal alignment layer to be formed is preferably 10 to 250 nm or so, more preferably 10 to 100 nm or so.

Using the liquid crystal alignment layer formed according to the above-mentioned method, for example, a liquid crystal cell having a liquid crystal composition sandwiched between a pair of substrates therein and a liquid crystal display device using the same can be produced.

Two substrates each having the above-mentioned liquid crystal alignment layer formed thereon are prepared, and a liquid crystal is arranged between the two substrates to produce a liquid crystal cell. The liquid crystal alignment layer may be formed on one alone of the two substrates.

The production method for the liquid crystal cell is, for example, as follows. First, two substrates are so arranged that the liquid crystal alignment layers formed on them could face each other, then the two are sealed up with a sealant around the peripheries thereof while a given cell gap is kept between the two substrates, then a liquid crystal is injected and filled into the cell gap as sectioned by the substrate surface and the sealant, and the injection hole is sealed up to construct a liquid crystal cell.

In addition, the liquid crystal cell can also be produced according to an ODF (one drop fill) method. For example, the process is as follows. For example, a UV-curable sealant is applied in a predetermined site on the substrate having a liquid crystal alignment layer formed thereon, then a liquid crystal is dropwise applied onto the liquid crystal alignment layer, thereafter another substrate is stuck thereto in such a manner that the liquid crystal alignment layers of the two could face each other, and the entire surface of the substrate is irradiated with UV rays to cure the sealant, thereby constructing a liquid crystal cell.

In any case where a liquid crystal cell is produced according to any such method, it is desirable that the cell is heated up to a temperature at which the liquid crystal used could be in an isotropic phase, and then gradually cooled to room temperature to remove the flow alignment at the injection time.

As the sealant, for example, an epoxy resin and the like can be used.

For keeping the cell gap constant, beads of silica gel, alumina, acrylic resin or the like can be used as a spacer prior to sticking the two substrates together. For the spacer, the beads may be sprayed on the alignment coating film, or after they are mixed with a sealant, the two substrates may be stuck together therewith.

As the liquid crystal, for example, a nematic liquid crystal can be used. For a vertical alignment liquid crystal cell, a liquid crystal having negative dielectric anisotropy is preferred. For a horizontal alignment liquid crystal cell, a liquid crystal having positive dielectric anisotropy is preferred. The liquid crystal to be used incudes, for example, a dicyanobenzene-type liquid crystal, a pyridazine-type liquid crystal, a Schiff base-type liquid crystal, an azoxy-type liquid crystal, a naphthalene-type liquid crystal, a biphenyl-type liquid crystal, a phenylcyclohexane-type liquid crystal, etc. By sticking a polarization film onto the outer surface of the thus-produced liquid crystal cell, a liquid crystal display device can be produced.

Examples of the polarization film include a polarization film of an “H film” that is produced through absorption of iodine with stretch alignment of polyvinyl alcohol, a polarization film produced by sandwiching the H film with protective cellulose acetate films, etc.

In this description, an optical axis is meant to indicate a direction in a liquid crystal display device or an optically-anisotropic body, in which even when a light that gives a constant refractive index and is not polarized is made to fall, birefringence does not occur and an ordinary ray and an extraordinary ray are the same or the difference therebetween is the minimum. In this description, alignment is meant to indicate that the liquid crystal molecules or the polymerizing liquid crystal molecules to form an optically-anisotropic body in the liquid crystal cell in a liquid crystal display device are aligned in a given direction, and in the case of rod-like liquid crystal molecules, the direction is the major axis direction of the molecule, while in the case of disc-like liquid crystal molecules, the direction is the normal direction relative to the disc plane. In this description, the pretilt angle is an angle between the alignment direction of a liquid crystal molecule or a polymerizing liquid crystal molecule and the substrate surface. In this description, the polymerizing liquid crystal means a compound that exhibits a liquid crystal phase and has a polymerizable chemical structure. In this description, homogeneous alignment means alignment in which the pretilt angle is 0 degree or more and 20 degrees or less. In this description, homeotropic alignment means alignment in which the pretilt angle is 70 degrees or more and 90 degrees or less. The angle of the optical axis to the substrate surface may be the same as or may not be the same as the pretilt angle.

### EXAMPLES

### Synthesis Example 1

In the same manner as that for the method described in Example 1 and Example 2 in JP-A 2013-33248, (M2-1) was synthesized. 2.0 g of a monomer (M2-1):

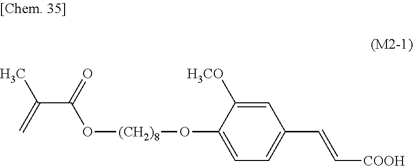

16.8 mg of AIBN and 20.2 mL of tetrahydrofuran (THF) were mixed in a flask, and stirred in a nitrogen atmosphere at 60° C. for 8 hours, and then hexane in an amount of 5 times the monomer amount used (5 mL relative to 1 g of the monomer) (in this Synthesis Example, 10 mL) was added thereto to precipitate the reaction mixture, and the supernatant was removed through decantation. The reaction mixture was redissolved in THF in an amount of 3 times the monomer amount used (3 mL relative to 1 g of the monomer) (in this Synthesis Example, 6 mL), and hexane in an amount of 5 times the monomer amount used (5 mL relative to 1 g of the monomer) (in this Synthesis Example, 10 mL) was added thereto to precipitate the reaction mixture, and the supernatant was removed through decantation. The operation of redissolution in THF, precipitation with hexane and decantation was repeated further 3 times, and the resultant reaction mixture was dried under reduced pressure and under a light-shielding condition at 20° C. and 0.13 kPa for 24 hours to give 1.71 g of a polymer of a formula (2-1).

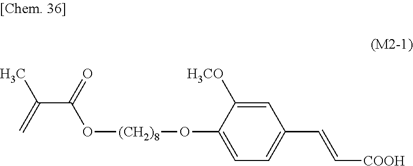

The molecular weight of the resultant polymer was determined through gel permeation chromatography (GPC) under the condition mentioned below, and the polyethylene-equivalent weight-average molecular weight (Mw) thereof was 50,352, the distribution ratio (Mw/Mn) was 2.15, and the residual monomer amount was 0.26%.

### <GPC Measurement Condition>

Columns: Shodex KF-803L, KF-804L, KF-805, KF-806 (all manufactured by Showa Denko KK) connected in series

Fluent: THF

Sample solution concentration: 0.1 (w/v) % (solvent THF)

Sample injection amount: 200 μL

Column temperature: 40° C.

Column flow rate: 1.0 mL/min

Detector: RI

Hereinunder the GPC measurement condition is the same as above.

### Synthesis Example 2

3.0 g of the monomer (M2-1), 115 mg of AIBN and 64 mL of THF were stirred at 60° C. for 4 hours, and then hexane in an amount of 23.3 times the monomer amount used (23.3 mL relative to 1 g of the monomer) (in this Synthesis Example, 70 mL) was added thereto to precipitate the reaction mixture, and the supernatant was removed through decantation. The reaction mixture was redissolved in THF in an amount of 1.5 times the monomer amount used (1.5 mL relative to 1 g of the monomer) (in this Synthesis Example, 4.5 mL), and hexane in an amount of 4 times the monomer amount used (4 mL relative to 1 g of the monomer) (in this Synthesis Example, 12 mL) was added thereto to precipitate the reaction mixture, and the supernatant was removed through decantation. The operation of redissolution in THF, precipitation with hexane and decantation was repeated further 3 times, and the resultant reaction mixture was dried under reduced pressure and under a light-shielding condition at 20° C. and 0.13 kPa for 24 hours to give 0.83 g of the polymer of the formula (2-1). The molecular weight of the resultant polymer was determined through GPC, and the polyethylene-equivalent weight-average molecular weight (Mw) thereof was 6,901, the distribution ratio (Mw/Mn) was 1.21, and the residual monomer amount was 0.07%.

### Synthesis Example 3

In the same manner as in Synthesis Example 1 except that 2.0 g of the monomer (M2-1), 16.8 mg of AIBN and 25 mL of THF were stirred at 60° C. for 6 hours, 1.26 g of the polymer of the formula (2-1) was produced. The molecular weight of the resultant polymer was determined through GPC, and the polyethylene-equivalent weight-average molecular weight (Mw) thereof was 32,994, the distribution ratio (Mw/Mn) was 1.65, and the residual monomer amount was 0.07%.

### Synthesis Example 4

In the same manner as in Synthesis Example 1 except that 70.0 g of the monomer (M2-1), 588 mg of AIBN and 708.5 mL of THF were used, 56.08 g of the polymer of the formula (2-1) was produced. The molecular weight of the resultant polymer was determined through GPC, and the polyethylene-equivalent weight-average molecular weight (Mw) thereof was 58,415, the distribution ratio (Mw/Mn) was 1.96, and the residual monomer amount was 0.06%.

### Synthesis Example 5

In the same manner as in Synthesis Example 1 except that 2.0 g of the monomer (M2-1), 16.8 mg of AIBN and 15.1 mL of THF were used, 1.65 g of the polymer of the formula (2-1) was produced. The molecular weight of the resultant polymer was determined through GPC, and the polyethylene-equivalent weight-average molecular weight (Mw) thereof was 85,390, the distribution ratio (Mw/Mn) was 2.34, and the residual monomer amount was 0.22%.

### Synthesis Example 6

In the same manner as in Synthesis Example 1 except that 4.0 g of a monomer (M2-2):

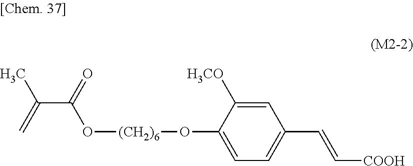

36.25 mg of AIBN and 20 mL of THF were stirred at 55° C. for 6 hours, 2.45 g of a polymer of a formula (2-2) was produced.

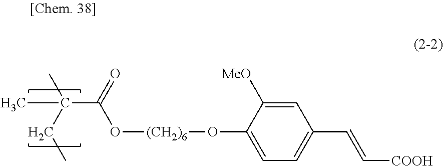

The molecular weight of the resultant polymer was determined through GPC, and the polyethylene-equivalent weight-average molecular weight (Mw) thereof was 129,823, the distribution ratio (Mw/Mn) was 2.31, and the residual monomer amount was 0.23%.

### Synthesis Example 7

In the same manner as in Synthesis Example 1 except that 3.0 g of the monomer (M2-2), 27.18 mg of AIBN and 21 mL of THF were stirred at 60° C. for 5 hours, 2.02 g of the polymer of the formula (2-2) was produced. The molecular weight of the resultant polymer was determined through GPC, and the polyethylene-equivalent weight-average molecular weight (Mw) thereof was 58,992, the distribution ratio (Mw/Mn) was 1.81, and the residual monomer amount was 0.03%.

### Synthesis Example 8

In the same manner as in Synthesis Example 1 except that 2.0 g of a monomer (M2-11):

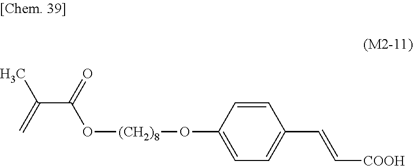

was used, 1.34 g of a polymer of a formula (2-11) was produced.

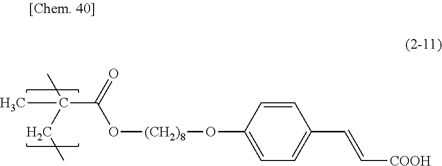

The molecular weight of the resultant polymer was determined through GPC, and the polyethylene-equivalent weight-average molecular weight (Mw) thereof was 57,404, the distribution ratio (Mw/Mn) was 1.89, and the residual monomer amount was 0.08%.

### Synthesis Example 9

In the same manner as in Synthesis Example 8 except that 4.0 g of the monomer (M2-11), 36 mg of AIBN and 20 mL of THF were stirred at 55° C. for 4 hours, 2.18 g of the polymer of the formula (2-11) was produced. The molecular weight of the resultant polymer was determined through GPC, and the polyethylene-equivalent weight-average molecular weight (Mw) thereof was 175,573, the distribution ratio (Mw/Mn) was 2.31, and the residual monomer amount was 0.05%.

### Synthesis Example 10

1.08 g of the monomer (M2-1), 1.0 g of the monomer (M2-11), 18.2 mg of AIBN and 23.3 mL of THF were stirred at 60° C. for 6.5 hours, and then hexane in an amount of 15 times the amount of the monomers used (15 mL relative to 1 g of the monomers) (in this Synthesis Example, 30 mL) was added thereto to precipitate the reaction mixture, and the supernatant was removed through decantation. The reaction mixture was redissolved in THF in an amount of 5 times the amount of the monomers used (5 mL relative to 1 g of the monomers) (in this Synthesis Example, 10 mL), and hexane in an amount of 12.5 times the amount of the monomers used (12.5 mL relative to 1 g of the monomers) (in this Synthesis Example, 25 mL) was added thereto to precipitate the reaction mixture, and the supernatant was removed through decantation. The operation of redissolution in THF, precipitation with hexane and decantation was repeated further 3 times, and the resultant reaction mixture was dried under reduced pressure and under a light-shielding condition at 20° C. and 0.13 kPa for 24 hours to give 1.38 g of a copolymer (4).

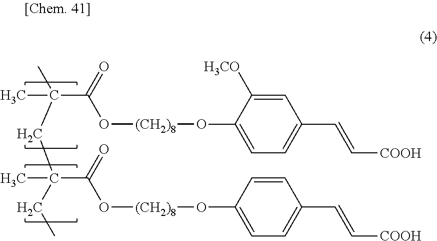

The molecular weight of the resultant polymer was determined through GPC, and the polyethylene-equivalent weight-average molecular weight (Mw) thereof was 47,376, the distribution ratio (Mw/Mn) was 1.97, and the residual monomer amount was 0.08%.

In the same manner as in the above-mentioned Synthesis Examples 1 to 10, the other polymers of compounds (1-1), (1-7), (1-15), (1-25), (1-33), (1-34), (1-44), (1-52), (1-62), (2-3) and (2-13) shown in the above-mentioned tables were synthesized.

### Example 1

### (Preparation of Polymerizing Liquid Crystal Composition)

Compounds represented by formulae (i), (ii), (iii), (iv) and (v) were mixed in a ratio of 22:18:33:22:5 to prepare a polymerizing liquid crystal composition, and an additive (vi) having a mass-average molecular weight of 47000 was mixed therein in an amount of 0.5 parts by mass relative to 100 parts by mass of the polymerizing liquid crystal composition. Next, this was filtered through a filter having a pore size of 0.1 μm. 96 parts of the polymerizing liquid crystal composition was mixed with 4 parts of a photopolymerization initiator “Irgacure 907” manufactured by Ciba Specialty Chemicals, Inc. and 100 parts of xylene to be a polymerizing liquid crystal composition solution (B-1). Xylene was evaporated out from the polymerizing liquid crystal composition solution (B-1), and the resultant liquid crystal composition showed a liquid phase at 25° C. Accordingly, in the following Examples, the liquid crystal composition was used at 25° C.

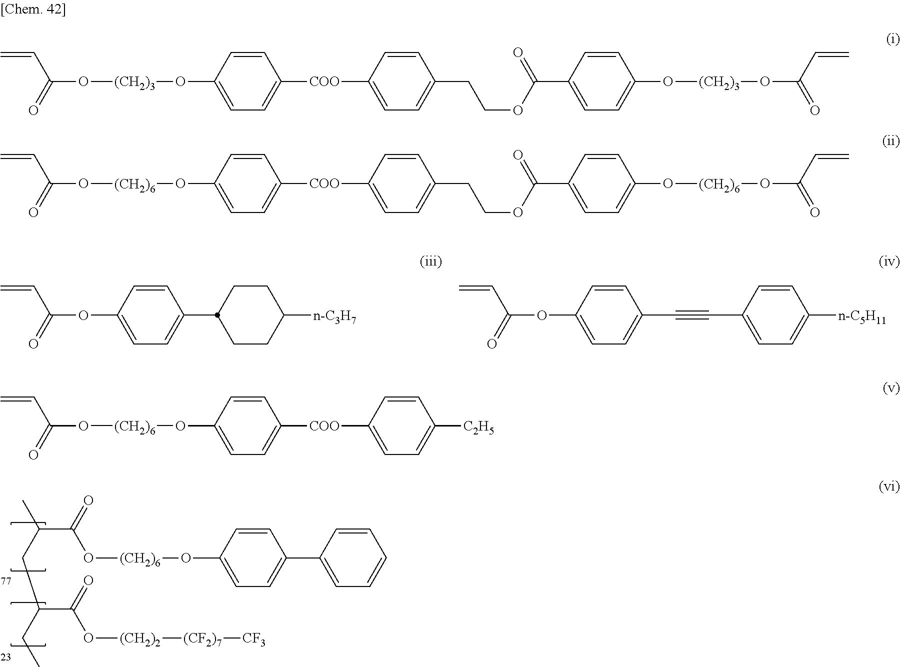

### (Preparation of Photo-Alignment Agent Solution)

A mixture of 2 parts of the polymer of the formula (2-1) in Synthesis Example 1 and 98 parts of 2-methoxyethanol was stirred at room temperature for 10 minutes to dissolve uniformly to prepare a photo-alignment agent solution.

### (Formation of Optical Film)

A surface of a polymethyl methacrylate (PMMA) film, on which a retardation film is to be formed, was corona-treated, and using a wire bar, the solution was applied onto the PMMA film, and dried at 80° C. for 3 minutes to form a film on the film. The thus-formed film was observed visually to reveal that a smooth film was formed.

Next, using a polarized light irradiation apparatus equipped with an ultrahigh-pressure mercury lamp, a wavelength cut filter, a band pass filter and a polarization filter, a linearly-polarized light (lighting intensity: 10 mW/cm²) of a UV ray (wavelength 313 nm) was applied to the formed film in a vertical direction for 3 seconds (irradiation light quantity 30 mJ/cm²) to form a photo-alignment layer. The film thickness was about 0.10 μm.

Using a wire bar, the polymerizing liquid crystal composition solution (B-1) was applied onto the photo-alignment layer, dried at 80° C. and then irradiated with 640 mJ/cm² of UV rays in a nitrogen atmosphere to form a retardation film having a thickness of about 1.0 μm, thereby producing an optical film layered with a retardation film formed of a photo-alignment layer and an optically-anisotropic layer.

### (Evaluation of Optical Film)

The optical films produced in Examples were evaluated according to the following evaluation method, and the results are shown in Table 1.

### (Evaluation of Alignment)

For evaluation of alignment of the optically-anisotropic layer formed on the film substrate, the contrast was measured. The optical film was arranged between the polarizer and the analyzer in an optical measurement apparatus (RETS-100, manufactured by Otsuka Electronics Co., Ltd.) equipped with a white light source, a spectroscope, a polarizer (incoming beam side polarization plate), an analyzer (outgoing beam side polarization plate) and a detector. At the rotation angle between the polarizer and the analyzer of 0 degree (at which the polarization direction of the polarizer and that of the analyzer are in parallel [parallel nicol]), and at a rotation position of the optical film at which the light quantity of the transmitted light detected with the detector while the optical film was rotated could be the largest (the polarization direction of the polarizer and the molecule major axis direction of the polymerizing liquid crystal composition are in parallel), the light quantity of the transmitted light (on-time light quantity) was referred to as Yₒₙ. On the other hand, the position of the polarizer and the optical film was kept fixed and the rotation angle between the polarizer and the analyzer was set at 90 degrees (at which the polarization direction of the polarizer and that of the analyzer are in a vertical state [cross nicol]), and the light quantity of the transmitted light (off-time light quantity) in this state was referred to as Y_{off}. The contrast CR was determined according to the following formula (formula 1).

CR=Yₒₙ/Y_{off} (Formula 1)

A larger value of the contrast CR of the (formula 1) means that the off-time light quantity Y_{off} is smaller, that is, the alignment degree of the polymerizing liquid crystal composition is higher (the alignment is better), and therefore the light quantity of the transmitted light in a cross nicol state is smaller.

### (Evaluation of Adhesion Force)

For evaluating the adhesion force between the retardation film formed on the film substrate and the film substrate, 1-mm² cross-cut squares were formed in the formed optically-anisotropic layer using a cutter knife, an adhesive tape (Sellotape™) was stuck thereto and drawn up in the vertical direction, and the number of the cross-cut squares of the optically-anisotropic layer that had remained on the film substrate was counted. A larger number of the remaining cross-cut squares indicates a higher adhesion force. In counting the number of the cross-cut squares, two polarizer plates were put on a backlight source in such a manner that the polarization directions thereof could be vertical to each other (cross nicol), the retardation film-attached substrate was put between the polarization plates, and when the substrate was rotated in the horizontal direction, the number of the cross-cut squares to provide repeated light interception/light transmission of the backlight was counted to indicate the number of the cross-cut squares with the optically-anisotropic layer left thereon. The samples in which almost all (70% or more) of the cross-cut squares remained was evaluated as good (A), those in which 30% to less than 70% remained was evaluated as average (B), and those in which a half or less remained or no cross-cut square remained was evaluated as bad “C”.

### [Evaluation of Haze]

The haze “%” of the produced optical film was measured using a haze meter NDH2000 (manufactured by Nippon Denshoku Industries Co., Ltd.). A sample having a lower value of haze is more transparent with less turbidity.

### Examples 2 to 7

Photo-alignment agent solutions were prepared in the same manner as in Example 1 except that the polymer of Synthesis Examples 2 to 7 was used in place of the polymer of Synthesis Example 1, and applied onto a corona-treated PMMA film substrate to produce optical films with an optically-anisotropic layer layered thereon. The resultant optical films were evaluated in the same manner as in Example 1.

### Example 8

### (Preparation of Photo-Alignment Agent Solution)

A mixture of 2 parts of the polymer of Synthesis Example 8, 97.7 parts of 2-methoxyethanol and 0.3 parts of propylamine was stirred at room temperature for 10 minutes and uniformly dissolved to prepare a photo-alignment agent solution. In the same manner as in Example 1 but using the solution, an optical film was produced and evaluated.

### Example 9

### (Preparation of Photo-Alignment Agent Solution)

A mixture of 2 parts of the polymer of Synthesis Example 9, 97.7 parts of 2-methoxyethanol and 0.3 parts of propylamine was stirred at room temperature for 10 minutes and uniformly dissolved to prepare a photo-alignment agent solution. In the same manner as in Example 1 but using the solution, an optical film was produced and evaluated.

### Example 10

A photo-alignment agent solution was prepared in the same manner as in Example 1 except that the polymer of Synthesis Example 10 was used in place of the copolymer of Synthesis Example 1, and applied onto a corona-treated PMMA film substrate to produce an optical film with an optically-anisotropic layer layered thereon. The resultant optical films were evaluated in the same manner as in Example 1.

### Comparative Examples 1 to 10

Optical films were produced in the same manner as in Examples 1 to 10 except that a corona-treated PET film substrate was respectively used in place of the corona-treated PMMA film substrate. The resultant optical films were evaluated in the same manner as in Example 1. The evaluation results of Examples and Comparative Examples are shown below.

TABLE 6

| | | Synthesis | Alignment | Adhesion | Haze |
|---|---|---|---|---|---|
| | Substrate | Example | (CR) | Force | [%] |
| Example 1 | PMMA | 1 | 4520 | A | 1.6 |
| Example 2 | PMMA | 2 | 337 | A | 5.3 |
| Example 3 | PMMA | 3 | 860 | A | 4.2 |
| Example 4 | PMMA | 4 | 4758 | A | 1.6 |
| Example 5 | PMMA | 5 | 5710 | A | 1.5 |
| Example 6 | PMMA | 6 | 2765 | A | 3.1 |
| Example 7 | PMMA | 7 | 2252 | A | 2.3 |
| Example 8 | PMMA | 8 | 1372 | B | 3.8 |
| Example 9 | PMMA | 9 | 3431 | B | 2.1 |
| Example 10 | PMMA | 10 | 1337 | A | 3.9 |
| Comparative | PET | 1 | 91 | C | 9.9 |
| Example 1 | | | | | |
| Comparative | PET | 2 | 51 | C | 15.6 |
| Example 2 | | | | | |
| Comparative | PET | 3 | 48 | C | 10.7 |
| Example 3 | | | | | |
| Comparative | PET | 4 | 88 | C | 7.6 |
| Example 4 | | | | | |
| Comparative | PET | 5 | 96 | C | 8.9 |
| Example 5 | | | | | |
| Comparative | PET | 6 | 75 | C | 11.9 |
| Example 6 | | | | | |
| Comparative | PET | 7 | 61 | C | 12.4 |
| Example 7 | | | | | |
| Comparative | PET | 8 | 55 | C | 12.2 |
| Example 8 | | | | | |
| Comparative | PET | 9 | 91 | C | 9.9 |
| Example 9 | | | | | |
| Comparative | PET | 10 | 51 | C | 15.6 |
| Example 10 | | | | | |

From the above results, the photo-alignment layer formed on an acrylic resin substrate using a photo-alignment agent that has a specific structure in an optical film having a retardation film of a photo-alignment layer and an optically-anisotropic layer layered therein exhibits high alignment performance relative to the polymerizing liquid crystal composition and exhibits sufficient adhesion performance. In addition, the optical film of the present invention exhibits high transparency.

1-9. (canceled)

10. A layered body having:
a transparent substrate containing polymethacrylate, and
as formed on one surface of the transparent substrate through spreading and bonding thereon, a photo-alignment layer containing photo-responsive molecules capable of responding to light,
the photo-responsive molecules contain a repeating unit represented by the following general formula (1): 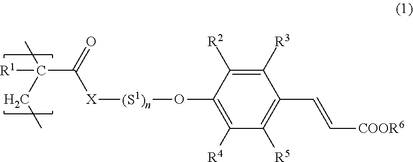
wherein R¹ represents a hydrogen atom or a methyl group, R² represents an alkoxy group having 1 to 6 carbon atoms, R³, R⁴ and R⁵ each independently represent a hydrogen atom, R⁶ represents a hydrogen atom,
X represents —O— or —NH—,
S¹ represents —O— or a methylene group which may be substituted with an alkyl group having 1 to 3 carbon atoms and/or a fluorine atom, provided that the oxygen atoms existing in the above general formula (1) are not adjacent to each other, and
n represents an integer of 2 to 20.

11. The layered body according to claim 10, wherein the photo-responsive molecules have a weight-average molecular weight of 10,000 to 200,000.

12. A method of preparing a layered body as described in claim 10, which comprises applying a solution containing, as essential components, a photo-responsive molecule having a repeating unit represented by the following general formula (1) and a solvent that contains a single solvent selected from methoxyethanol, ethyl cellosolve, propyl cellosolve and butyl cellosolve or a mixed solvent composed of the plural solvents selected therefrom as a component having a highest weight ratio onto one surface of a transparent substrate containing polymethacrylate, followed by drying, to form a dry coating film, and irradiating the dry coating film with polarized light to form a photo-alignment film: 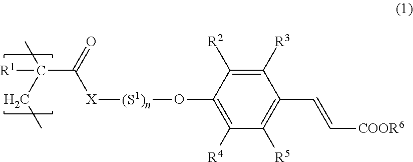
wherein R¹ represents a hydrogen atom or a methyl group, R² represents an alkoxy group having 1 to 6 carbon atoms, R³, R⁴ and R⁵ each independently represent a hydrogen atom, R⁶ represents a hydrogen atom,
X represents —O— or —NH—,
S¹ represents —O— or a methylene group which may be substituted with an alkyl group having 1 to 3 carbon atoms and/or a fluorine atom, provided that the oxygen atoms existing in the above general formula (1) are not adjacent to each other, and
n represents an integer of 2 to 20.

13. The method of claim 12, wherein the photo-responsive molecules have a weight-average molecular weight of 10,000 to 200,000.

14. A method of preparing a layered body described in claim 10, which comprises coating a solution containing, as essential components, a monomer represented by the following general formula (3); and a solvent that contains a single solvent selected from methoxyethanol, ethyl cellosolve, propyl cellosolve and butyl cellosolve or a mixed solvent composed of the plural solvents selected therefrom onto one surface of a transparent substrate containing polymethacrylate, followed by drying, to form a dry coating film, then
1) subjecting the dry coating film to polymerization by heat, and then irradiating the polymerized coating with polarized light to thereby form a photo-alignment film, or
2) irradiating the dry coating film with polarized light to thereby form a photo-alignment film: 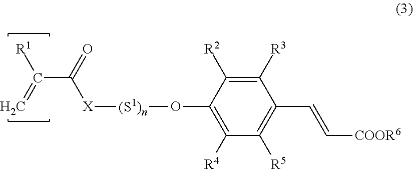
wherein R¹ represents a hydrogen atom or a methyl group. R² represents an alkoxy group having 1 to 6 carbon atoms, R³, R⁴ and R⁵ each independently represent a hydrogen atom, R⁶ represents a hydrogen atom, or an alkyl group having 1 to 6 carbon atoms which may be substituted with a cyano group or an alkoxy group living 1 to 3 carbon atoms, X represents —O— or —NH—, S¹ represents —O— or a methylene group which may be substituted with an alkyl group having 1 to 3 carbon atoms and/or a fluorine atom, provided that the oxygen atoms existing in the above general formula (1) are not adjacent to each other, and n represents an integer of 2 to 20.

15. An optical film having a layered body as described in claim 10, wherein:
an optically-anisotropic layer having optical anisotropy is formed to be in adjacent to the surface of the photo-alignment film formed in the layered body.

16. An optical film having a layered body as described in claim 11, wherein:
an optically-anisotropic layer having optical anisotropy is formed to be in adjacent to the surface of the photo-alignment film formed in the layered body.

17. The optical film according to claim 15, wherein the layer having optical anisotropy contains a polymerizable liquid crystal material.

18. The optical film according to claim 16, wherein the layer having optical anisotropy contains a polymerizable liquid crystal material.

19. A method of preparing an optical film, which comprises preparing a layered body having a photo-alignment film according to claim 12, and subsequently polymerizable a composition containing a polymerizing liquid crystal material to form a layer having optical anisotropy on the photo-alignment film.

20. A method of preparing an optical film, which comprises preparing a layered body having a photo-alignment film according to claim 13, and subsequently polymerizable a composition containing a polymerizing liquid crystal material to form a layer having optical anisotropy on the photo-alignment film.

21. A method of preparing an optical film, which comprises preparing a layered body having a photo-alignment film according to claim 14, and subsequently polymerizable a composition containing a polymerizing liquid crystal material to form a layer having optical anisotropy on the photo-alignment film.
